(19) United States
(12) Patent Application Publication
(10) Pub. No.: US 2026/0333248 A1
(43) Pub. Date: Oct. 22, 2026

(54) TRANSPARENT LAYER AND MECHANISM FACILITATING CONCURRENT ACCESS OF DIFFERENT ACCELERATOR FUNCTIONS BY L2 LAYER

(71) Applicant: Dell Products L.P., Round Rock, TX (US)

(72) Inventors: Neeraj Sharma, Fremont, CA (US); Abdul Khader Thakkadi Mohamed Kalvath Syed, Pleasanton, CA (US)

(21) Appl. No.: 19/182,142

(22) Filed: Apr. 17, 2025

(51) Int. Cl. H04W 52/36; H04L 5/14; H04W 52/26; H04W 64/00

(52) U.S. Cl. CPC H04W 52/367; H04L 5/1469; H04W 52/265; H04W 64/00

(57) ABSTRACT

Access and utilization of respective accelerator functions of respective L1 layers by L2 layer, via transparent layer, of a RAN can be managed and performed. In the RAN, transparent layer can be situated between L2 layer and respective L1 layers, comprising first L1 layer associated with first accelerator function and second L1 layer associated with second accelerator function. Accelerator function manager (AFM) can determine conditions associated with RAN based on condition information. Based on conditions, AFM can control access to first accelerator function and second accelerator function by L2 layer, via transparent layer. To facilitate such controlling, AFM can determine whether threshold change has occurred with regard to the conditions or rules relating to accelerator function management. If threshold change has occurred, AFM can determine whether to switch from L2 layer accessing one accelerator function to accessing another accelerator function, via transparent layer, based on the conditions and rules.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise: determining, by a system comprising at least one processor, communication-related conditions associated with radio access network equipment based on an analysis of information relating to the communication-related conditions, wherein the radio access network equipment can comprise a layer two (L2) layer, respective layer one (L1) layers, and a transparent layer, and wherein the respective L1 layers can comprise a first L1 layer and a second L1 layer. The method also can comprise: based on the communication-related conditions, controlling, utilizing a transparent layer function of the system, access of at least a first accelerator function of the first L1 layer and a second accelerator function of the second L1 layer by the L2 layer via the transparent layer.

In certain embodiments, the disclosed subject matter can comprise a system that can comprise at least one memory that can store computer executable components, and at least one processor that can execute computer executable components stored in the at least one memory. The computer executable components can comprise a condition evaluator that can determine conditions associated with radio access network (RAN) equipment based on an evaluation of condition data relating to the conditions, wherein the RAN equipment can comprise an L2 layer, respective L1 layers, and a transparent layer, and wherein the respective L1 layers can comprise a first L1 layer and a second L1 layer. The computer executable components also can comprise an accelerator function manager of the transparent layer that, based on the conditions, can manage access, by the L2 layer via the transparent layer, of at least a first accelerator function of the first L1 layer and a second accelerator function of the second L1 layer.

In still other embodiments, the disclosed subject matter can comprise a non-transitory machine-readable medium, comprising executable instructions that, when executed by at least one processor, can facilitate performance of operations. The operations can comprise evaluating conditions associated with a base station based on condition information relating the conditions, wherein the base station can comprise an L2 layer, respective L1 layers, and a transparent layer, and wherein the respective L1 layers can comprise a first L1 layer and a second L1 layer. The operations also can comprise: based on the evaluation of the conditions, controlling access of at least a first accelerator function of the first L1 layer and a second accelerator function of the second L1 layer by the L2 layer via the transparent layer.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage access and utilization of respective accelerator functions of respective layer one (L1) layers by a layer 2 (L2) layer, via a transparent layer, of a radio access network (RAN), in accordance with various aspects and embodiments of the disclosed subject matter.

FIG. 2 depicts a block diagram of a distributed unit (DU), comprising the transparent layer and an accelerator function manager component, in accordance with various aspects and embodiments of the disclosed subject matter.

FIG. 3 illustrates a block diagram of a non-limiting example DU that can comprise the transparent layer and the accelerator function manager component that can manage access by the L2 layer to multiple accelerator functions, via respective dedicated channels that can be associated with respective accelerator functions, in accordance with various aspects and embodiments of the disclosed subject matter.

FIG. 4 depicts a block diagram of non-limiting example system that can comprise the transparent layer and the accelerator function manager component in the RAN in an open RAN (O-RAN) communication network environment to facilitate desirable management and performance of access and utilization of respective accelerator functions of respective L1 layers by the L2 layer, via the transparent layer, of the RAN.

FIG. 5 depicts a diagram of a non-limiting example base station that can desirably facilitate connections and communication of information associated with devices, in accordance with various aspects and embodiments of the disclosed subject matter.

FIG. 6 illustrates a diagram of a non-limiting example device that can be operable to engage in a system architecture that facilitates wireless communications according to one or more embodiments described herein, in accordance with various aspects and embodiments of the disclosed subject matter.

FIG. 7 illustrates a flow chart of an example method that can desirably manage access and utilization of respective accelerator functions of the respective L1 layers by the L2 layer, via the transparent layer, of the RAN, in accordance with various aspects and embodiments of the disclosed subject matter.

FIG. 8 depicts a flow chart of another example method that can desirably manage access and utilization of the respective accelerator functions of the respective L1 layers by the L2 layer, via the transparent layer, of the RAN, in accordance with various aspects and embodiments of the disclosed subject matter.

FIG. 9 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can employ a transparent layer and mechanism that can facilitate (e.g., enable or allow) concurrent (e.g., simultaneous or in parallel) access of respective (e.g., different) accelerator functions and architectures of respective layer 1 (L1) layers by a layer 2 (L2) layer (e.g., an L2 media access control (MAC) layer) of a radio access network (RAN) (e.g., an L2 MAC layer of a distributed unit (DU) of a disaggregated RAN).

Disaggregated RAN (e.g., fifth generation (5G) or other next generation or new radio (NR) disaggregated RAN) is seemingly a future-safe evolving alternate technology for processing the baseband signals in the wireless communication systems. The processing of the baseband signal can be a significantly compute intensive and cumbersome part of the wireless communication technology. Existing baseband signal processing technology can be built based on special designed hardware, however, recent developments in processing of baseband signals have introduced the disaggregation of hardware and software. Such disaggregation can enable the baseband signal processing on general purpose processor (GPP) based hardware with some optional assistance of computing offloading of heavier computational tasks. The processing of baseband signals also can be known as RAN network function. The RAN network function cumulatively can be achieved by central unit (CU), DU and radio unit (RU) network functions of the RAN. The CU can constitute the processes of control signals and user data at layer 3 (L3) of open systems interconnection (OSI) layers. The DU can constitute the L2 MAC layer and layer 1 (L1) physical (PHY) layer (e.g., upper part of PHY layer). The RU can constitute the lower part of the L1 PHY layer, including analog radio frequency (RF) signals. The DU function can process the L1 and L2 layers of networking in real-time or at least near real-time. The tasks of the L2 layer, which also can be referred to or can comprise a MAC scheduler, typically can be done in a central processing unit (CPU). However, tasks of the L1 Layer, which also can be referred to as the high PHY layer, can involve (e.g., utilize, want, or require) additional processing (e.g., acceleration processing), because such L1 layer tasks can be significantly computing intensive in nature. The L1 acceleration has truly evolved in two different architectures, look-aside acceleration and inline acceleration. So the RAN vendors can be divided into two camps on adoption of these two different types of L1 accelerations. One camp can prefer look-aside-based L1 acceleration, while the other camp can prefer inline-based L1 acceleration. Under existing technology and techniques, both the look-aside and inline acceleration architectures can involve their own L2 (MAC) layer of DU function. That is, under existing technology and techniques, the look-aside acceleration architecture can involve (e.g., utilize, want, or require) its own L2 (MAC) layer of DU function, and the inline acceleration architecture can involve (e.g., utilize, want, or require) its own L2 (MAC) layer of DU function separate and different from that of the look-aside acceleration architecture. The existing technology and techniques can be undesirable, deficient, and problematic for a number of reasons, as it can result in utilization of an undesirably higher amount of resources and/or energy, it can result in undesirable (e.g., substandard, unsuitable, inefficient, deficient, or otherwise undesirable) baseband signal processing by the RAN, it can result in undesirable quality of service (QoS) or perceived QoS by the RAN, and/or it can result in undesirable overall performance of the RAN.

It can be desirable to address and overcome the aforementioned deficiencies and other deficiencies of the existing systems, technology, and techniques. In that regard, the disclosed subject matter can provide enhanced systems, methods, and techniques that can desirably (e.g., suitably, beneficially, advantageously, usefully, enhancedly, or optimally) address and overcome the aforementioned deficiencies and other deficiencies of the existing systems and techniques.

To that end, techniques that can desirably (e.g., automatically, dynamically, suitably, reliably, efficiently, enhancedly, and/or optimally) manage access (e.g., concurrent access) and utilization of respective accelerator functions of respective L1 layers by an L2 layer (e.g., L2 MAC layer), via a transparent layer, of a RAN, are presented. A system can comprise a communication network that can comprise a core network and one or more RANs. The core network that can be associated with (e.g., communicatively connected to) the one or more RANs. The core network can comprise various network functions, components, and equipment that can facilitate communication (e.g., wireless communication) of information (e.g., voice traffic, data traffic) to or from devices (e.g., communication in devices) associated with (e.g., wirelessly connected to) the core network or another network of the communication network. A RAN can comprise one or more base stations that can facilitate communication (e.g., wireless communication) of data between devices associated with the communication network (e.g., communicatively connected to a base station of the core network, or otherwise connected to the communication network). In some embodiments, the RAN can be a disaggregated RAN, such as described herein.

In some embodiments, a base station of the RAN can comprise a CU, one or more DUs, and one or more RUs. In accordance with various embodiments, the base station can comprise or can be associated with an accelerator function manager component (e.g., of or associated with the DU of the base station) that can desirably (e.g., automatically, dynamically, suitably, reliably, efficiently, enhancedly, and/or optimally) manage (e.g., control) access (e.g., concurrent, simultaneous, and/or parallel access) and utilization of the respective accelerator functions of the respective L1 layers by the L2 layer, via the transparent layer, of the RAN, in accordance with defined accelerator function management criteria. In certain embodiments, the DU can comprise the L2 layer, the respective L1 layers (e.g., a first L1 layer, a second L1 layer, and/or another L1 layer), and the transparent layer, which can be situated (e.g., physically and/or logically situated) between the L2 layer and the respective L1 layers to facilitate management of access (e.g., for baseband processing) of the respective accelerator functions associated with the respective L1 layers by the L2 layer. In accordance with various embodiments, the respective accelerator functions can comprise a look-aside accelerator function (e.g., a look-aside-based L1 accelerator function) associated with the first L1 layer, an inline accelerator function (e.g., an inline-based L1 accelerator function) associated with the second L1 layer, and/or another type of accelerator function associated with the other L1 layer.

In some embodiments, the accelerator function manager component can determine conditions associated with the RAN based at least in part on the results of an analysis of condition-related information relating to or indicating conditions associated with the RAN and/or devices associated with the RAN. Based at least in part on the conditions associated with the RAN and a group of rules relating to accelerator function management and conditions associated with the RAN, the accelerator function manager component can control access to and utilization of the respective accelerator functions (e.g., the first accelerator function, second accelerator function, and/or other accelerator function) by the L2 layer, via the transparent layer. In certain embodiments, to facilitate the controlling of access to the respective accelerator functions by the L2 layer via the transparent layer, the accelerator function manager component can determine whether a defined threshold change (e.g., a threshold amount of change, or other threshold change) has occurred with regard to the conditions associated with the RAN or the group of rules, based on the results of analyzing the conditions and the group of rules (e.g., determine whether there has been a defined threshold amount of change in a condition(s), as specified or indicated by the group of rules; or determine whether there has been a defined threshold change in the group of rules).

If the accelerator function manager component determines that the defined threshold change has not occurred, the accelerator function manager component can determine that there does not have to be an evaluation of whether there is to be a change of access by the L2 layer, via the transparent layer, from one accelerator function to another accelerator function and/or there does not have to be a change of access by the L2 layer, via the transparent layer, from one accelerator function to another accelerator function. If, instead, the accelerator function manager component determines that the defined threshold change has occurred, the accelerator function manager component can determine that the respective accelerator functions are to be evaluated in relation to the conditions and the group of rules, and, based at least in part on the results of such evaluation, the accelerator function manager component can determine whether there is to be a change (e.g., switch or modification) of access by the L2 layer, via the transparent layer, from one accelerator function to another accelerator function. If, based at least in part on the results of such evaluation of the conditions and the group of rules, the accelerator function manager component determines there is to be a change of access by the L2 layer, via the transparent layer, from one accelerator function to another accelerator function, the accelerator function manager component can manage the transparent layer, the respective accelerator functions, the respective L1 layers, and/or the L2 layer to change access by the L2 layer, via the transparent layer, from one accelerator function to another accelerator function.

The disclosed subject matter, by employing the accelerator function manager component associated with the RAN and the enhanced techniques described herein, can desirably (e.g., automatically, dynamically, suitably, reliably, efficiently, enhancedly, and/or optimally) manage access (e.g., concurrent access) and utilization of the respective accelerator functions associated with the respective L1 layers by the L2 layer, via the transparent layer, of the RAN. Also, the disclosed subject matter, by employing the accelerator function manager component associated with the RAN and the enhanced techniques described herein, can desirably enhance access (e.g., concurrent access) of accelerator functions by the L2 layer (e.g., a single L2 layer or single instance of L2 layer), as compared to existing systems, methods, and techniques relating to accelerator function management and access. Further, the disclosed subject matter, by employing the accelerator function manager component associated with the RAN and the enhanced techniques described herein, can enhance energy and resource utilization (e.g., can reduce or conserve energy and resource consumption) by the RAN, as compared to existing systems, methods, and techniques relating to accelerator function management and access. Also, the disclosed subject matter, by employing the accelerator function manager component associated with the RAN and the enhanced techniques described herein, can enhance QoS, perceived QoS, quality of experience (QoE), and overall performance associated with the RAN, as compared to existing systems, methods, and techniques relating to accelerator function management and access.

These and other aspects and embodiments of the disclosed subject matter will now be described with respect to the drawings.

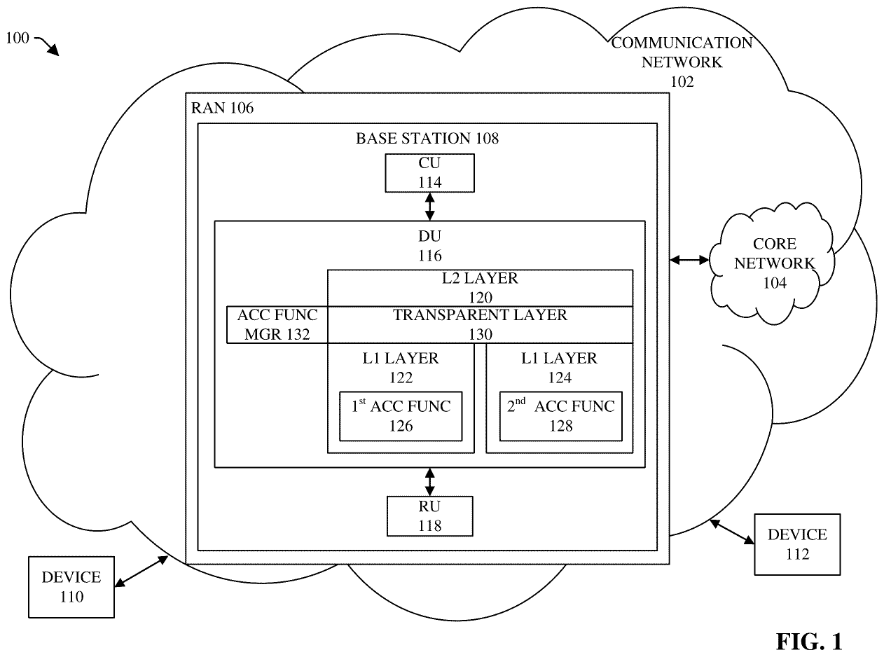

Referring now to the drawings, FIG. 1 illustrates a block diagram of a non-limiting example system 100 that can desirably (e.g., automatically, dynamically, suitably, reliably, efficiently, enhancedly, and/or optimally) manage access (e.g., concurrent access) and utilization of respective accelerator functions of respective L1 layers by an L2 layer, via a transparent layer, of a RAN, in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations, such as base station 108, that each can comprise one or more cells (not shown in FIG. 1). In some embodiments, the RAN (e.g., RAN 106 or another RAN) can be a disaggregated RAN, such as described herein.

In accordance with various embodiments, the core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) can be a 5G or other NR base station (e.g., gNB or other NR-type or xG base station, wherein x can be a number greater than 5). In some embodiments, the RAN 106 can be an open RAN (O-RAN) that can be part of an O-RAN architecture and environment (e.g., the communication network 102 can employ an O-RAN architecture and environment). In certain embodiments, the core network 104 can comprise a user plane function (UPF) (also can be referred to as a UPF node), an application function (AF) (also can be referred to as an AF node), an application server, an access and mobility management function (AMF), and/or other network functions (not shown in FIG. 1 for reasons of brevity and clarity). In some embodiments, the UPF can connect to or interface with the one or more RANs (e.g., RAN 106) and the one or more base stations, can be an interconnect point between the core network 104 and a data network (DN), can provide or facilitate providing a protocol data unit (PDU) session anchor point for providing mobility associated with radio access technologies (RATs), can provide or facilitate providing data packet routing or forwarding, and/or can perform or manage other functions.

In some embodiments, the AF, which can be a control plane function, can be associated with, and can act as or fulfill all or part of the role of, the application server, and can interact and communicate with other network functions, including control plane functions, of the core network 104. In certain embodiments, the AF and associated application server can facilitate (e.g., enable) provision of various services (e.g., voice services, messaging services, media streaming services, Internet and intranet services, multimedia conferencing and collaboration services, or other services) and applications to devices associated with the core network 104. In some embodiments, some of the services can be low latency services and/or network edge services. The AF can comprise one or more AFs that respectively can be owned or managed by the network operator of the core network 104 or by third parties (e.g., trusted third parties). In some embodiments, the UPF can be associated with, and can interact and communicate with, the AF and/or other network functions (e.g., other control plane functions) via a service-based interface (SBI).

In certain embodiments, the AMF node can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) can comprise both 4th generation (4G) long term evolution (LTE) technology and functions, and 5G or other NR-type or xG technology and functions.

In accordance with various embodiments, the communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services or applications. The services or applications can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

With further regard to the one or more RANs (e.g., the RAN 106), in some embodiments, one or more of the RANs, such as the RAN 106, can be a disaggregated RAN that can comprise a CU 114, one or more DUs, such as DU 116, and one or more RUs, such as RU 118, such as described herein. In certain embodiments, the DU 116 can be located in a first location (e.g., first geographic location), the CU 114 can be located in the first location or a second location, and/or the RU 118 can be located in the first location, the second location, or a third location. That is, in accordance with various embodiments, the CU 114, DU 116, and/or RU 118 can be co-located, or can be located in disparate geographic locations.

In some embodiments, the DU 116 can comprise an L2 layer 120, and a desired number of L1 layers, comprising L1 layer 122, L1 layer 124, and/or another L1 layer(s). In certain embodiments, the L2 layer 120 can be or can comprise an L2 MAC layer, which can comprise an L2 MAC scheduler that can perform scheduling and/or allocation of resources for or to devices (e.g., devices 110 and/or 112) associated with the RAN 106 (e.g., associated with the DU 116 of the RAN 106) to facilitate communication (e.g., voice and/or data communication) between the devices and the RAN 106 and ensuring that desired QoS associated with the communications can be achieved and priority communications can be desirably managed.

In certain embodiments, the respective L1 layers (e.g., L1 layer 122, L1 layer 124, and/or other L1 layer) can be associated with respective accelerator functions, such as a first accelerator function (1^{st} ACC FUNC) 126 associated with the L1 layer 122, a second accelerator function (2^{nd} ACC FUNC) 128 associated with the L1 layer 124, and/or another accelerator function associated with another L1 layer. In some embodiments, the first accelerator function 126 can be a look-aside accelerator function (or another type of accelerator function), the second accelerator function 128 can be an inline accelerator function (or another type of accelerator function), and/or the other accelerator function can be still another type of accelerator function. In certain embodiments, the look-aside accelerator function (e.g., L1 look-aside accelerator) can comprise a look-aside accelerator architecture where the processor (e.g., CPU or other processor) can essentially act or operate as a master controller for L1 processing, and where look-aside accelerator function can handle and perform certain functions. In some embodiments, the inline accelerator function (e.g., L1 inline accelerator) can comprise an inline accelerator architecture that can capture L1 processing for data, such as user plane data, before it reaches the processor (e.g., CPU), wherein the inline accelerator function can desirably handle and perform various L1 processing tasks.

As disclosed, existing technology and techniques relating to use of L1 accelerators can be undesirable, deficient, and problematic for a number of reasons, as existing technology and techniques can result in utilization of an undesirably higher amount of resources and/or energy, can result in undesirable (e.g., substandard, unsuitable, inefficient, deficient, or otherwise undesirable) baseband signal processing by the RAN, can result in undesirable QoS or perceived QoS by the RAN, and/or can result in undesirable overall performance of the RAN, among other problems.

The disclosed subject matter can overcome these deficiencies and other problems of existing systems, technology, and techniques. To that end, in accordance with various embodiments, the system 100 (e.g., the RAN 106 or base station 108) can comprise a transparent layer 130 (or other type of transparent mechanism) and an accelerator function manager component (ACC FUNC MGR) 132 (e.g., comprising or employing a transparent layer function of or associated with the transparent layer 130), of or associated with the transparent layer 130, that desirably (e.g., automatically, dynamically, suitably, reliably, efficiently, enhancedly, and/or optimally) can manage access (e.g., concurrent, simultaneous, or parallel access, and/or transparent access) and utilization of the respective accelerator functions (e.g., 126, 128) associated with the respective L1 layers (e.g., 122, 124) by the L2 layer 120 (e.g., a single L2 layer or single instance of L2 layer), via the transparent layer 130, of the RAN 106, in accordance with various aspects and embodiments of the disclosed subject matter. In some embodiments, the transparent layer 130 and/or the accelerator function manager component 132 can be part of the DU 116 (as depicted in FIG. 1). In certain embodiments, the transparent layer 130 can be situated (e.g., physically and/or logically situated) between the L2 layer 120 and the respective L1 layers (e.g., 122, 124) to facilitate management of access of the respective accelerator functions (e.g., 126, 128) associated with the respective L1 layers by the L2 layer 120. In other embodiments, the transparent layer 130 and/or the accelerator function manager component 132 can be separate from and associated with (e.g., communicatively, physically, and/or logically connected to) the DU 116. For instance, the transparent layer 130 and/or the accelerator function manager component 132 can be a stand-alone driver(s) that can be associated with the DU 116.

In some embodiments, the transparent layer 130 can be transparent and/or agnostic with respect to the respective L1 layers (e.g., 122, 124), and/or transparent and/or agnostic with respect to the L2 layer 120. For instance, the transparent layer 130 can be agnostic of the underlying respective accelerator function architectures of the respective accelerator functions (e.g., 126, 128). In other embodiments, the transparent layer 130 may not be agnostic with respect to vendor-specific and/or proprietary information of a vendor of an L1 layer, depending in part on the design of the L1 layer, wherein the transparent layer 130 can handle such L1 layer with desired care and proper translation of time to interval (TTI) schedules before invoking the selected L1 accelerator function. If the L1 accelerator functions are from the same vendor, implementation of the transparent layer mechanism can be less complex and more transparent. The proprietary information of the vendor can be handled transparently as part of implementing the transparent layer mechanism for both downlink and uplink messaging.

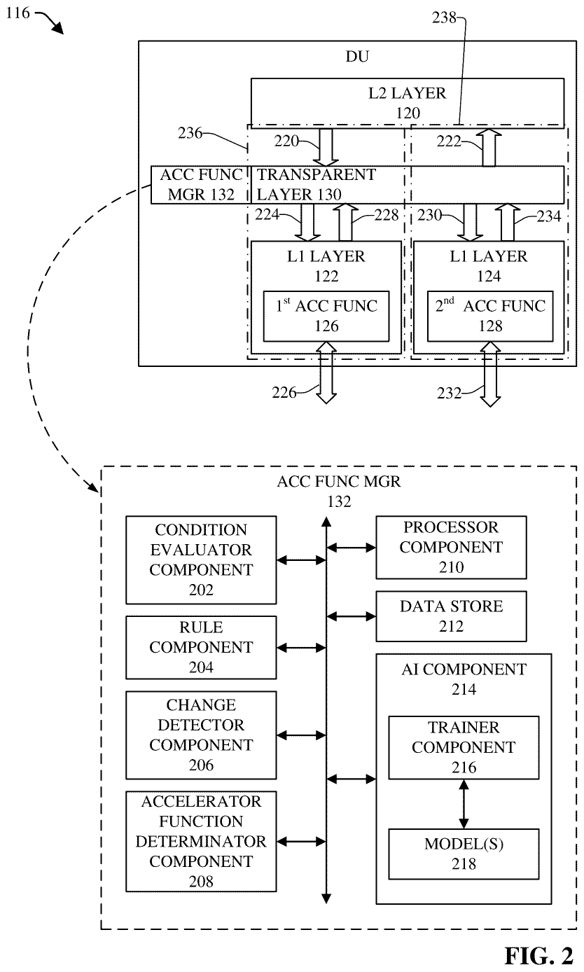

Referring to FIG. 2 (along with FIG. 1), FIG. 2 depicts a block diagram of the DU 116, comprising the transparent layer 130 and the accelerator function manager component 132, in accordance with various aspects and embodiments of the disclosed subject matter. In some embodiments, the accelerator function manager component 132 can comprise a condition evaluator component 202, a rule component 204, a change detector component 206, and an accelerator function determinator component 208. In certain embodiments, the accelerator function manager component 132 can comprise or can be associated with a processor component 210 and a data store 212. In some embodiments, the accelerator function manager component 132 can comprise or can be associated with an artificial intelligence component 214, which can comprise a trainer component 216 and one or more models 218 (e.g., trained AI-based models), such as described herein.

In some embodiments, the rule component 204 can comprise a group of rules (or respective groups of rules) that can relate to acceleration function management and access, and conditions (e.g., key performance indicators (KPIs) and/or other conditions) associated with the RAN 106, and the data store 212 can store the group of rules (or the respective groups of rules). The group of rules can, for example, indicate or specify respective conditions under which respective accelerator functions (e.g., 126, 128) can be accessed and utilized by the L2 layer 120, via the transparent layer 130, or other conditions under which multiple accelerator functions (e.g., 126, 128) can be accessed and utilized by the L2 layer 120, via the transparent layer 130 (e.g., can indicate or specify a first group of conditions under which the first accelerator function 126 can be accessed and utilized by the L2 layer 120, via the transparent layer 130, a second group of conditions under which the second accelerator function 128 can be accessed and utilized by the L2 layer 120, via the transparent layer 130, and/or a third group of conditions under which both accelerator functions (e.g., 126, 128) can be accessed and utilized by the L2 layer 120, via the transparent layer 130, in accordance with the defined accelerator function management criteria. In certain embodiments, the group of rules can be pre-loaded into the accelerator function manager component 132 and/or the transparent layer 130. The group of rules also can be changed over time, if and as desired (e.g., for specific cell sites of the RAN 106), in accordance with the defined accelerator function management criteria. In some embodiments, the accelerator function manager component 132 and/or the transparent layer 130 can utilize and/or follow the rules of the group of rules to bridge and/or connect the L2 layer 120 to the desired L1 layer (e.g., L1 layer 122 and/or L1 layer 124) and associated desired accelerator function(s) (e.g., accelerator function 126 and/or accelerator function 128).

In certain embodiments, the accelerator function manager component 132 can monitor conditions (e.g., communication-related, RAN-related, or other conditions) associated with the RAN 106 and/or devices (e.g., 110 and/or 112) associated with the RAN 106. For instance, the accelerator function manager component 132 (or another component of or associated with the RAN 106) can monitor the conditions associated with the RAN 106 (e.g., CU 114, DU 116, RU 118, cells of the RAN 106, the core network 104, the accelerator functions (e.g., 126, 128), devices (e.g., 110 and/or 112) associated with the RAN 106, and/or other components of or associated with the RAN 106). For example, the accelerator function manager component 132 (or another component of or associated with the RAN 106) can monitor conditions, such as a data traffic load (e.g., user data traffic load), L1 resource utilization, spectral efficiency, the impact of certain events and channel conditions on multiple input, multiple output (MIMO) streams, downlink and uplink block error rate (BLER), processor (e.g., CPU) utilizations, and/or other conditions or factors, such as described herein. It is noted, for example, that the impact of special events or channel conditions on the L1 acceleration can directly affect the perceived QoS, and the accelerator function manager component 132 and transparent layer 130 can utilize the most desirable features of the respective accelerator functions (e.g., 126 and/or 128) to provide a desirable (e.g., suitable, efficient, enhanced, or optimal) experience (e.g., to the user) and RAN performance, which was not available in existing baseband processing technologies. Based at least in part on such monitoring of the conditions, the accelerator function manager component 132 can receive, obtain, or collect condition-related information that can relate to or indicate the conditions (e.g., communication-related, RAN-related, or other conditions) associated with the RAN 106 and/or devices associated with the RAN 106.

In some embodiments, the accelerator function manager component 132, employing the condition evaluator component 202, can determine the conditions (e.g., communication-related, RAN-related, or other conditions) associated with the RAN 106 based at least in part on the results of an analysis of the condition-related information relating to or indicating the conditions associated with the RAN 106 and/or the devices (e.g., 110 and/or 112) associated with the RAN 106. In certain embodiments, the accelerator function manager component 132 also can monitor the group of rules, and can determine the status of the group of rules, including determining whether there have been any changes to the group of rules, based at least in part on the results of an analysis of the group of rules. The conditions and/or the group of rules can relate to, for example, a duplex type (e.g., frequency division duplexing (FDD), time division duplexing (TDD), or other duplex type) utilized for data communication, a carrier band, a carrier bandwidth (e.g., in megahertz (MHz)), an active spectrum (e.g., MHz times MIMO layers), a numerology (e.g., 5g or xG), a TTI, respective QoS or perceived QoS values associated with the respective L1 layers (e.g., 122, 124), a mapping of the respective accelerator functions (e.g., 126, 128) to respective time periods (e.g., minutes, hours, time of day, days, nights, weekdays, weekend days, holidays, special days, or other time period), an event (e.g., a special event, a sporting event, an entertainment event, or other event), a hardware fault, a software fault, a maintenance activity, an upgrade activity, and/or another conditions associated with the RAN 106.

In accordance with various embodiments, based at least in part on the conditions associated with the RAN and the group of rules, the accelerator function manager component 132 can control access to and utilization of the respective accelerator functions (e.g., the first accelerator function 126, second accelerator function 128, and/or other accelerator function) by the L2 layer 120 (e.g., a single L2 layer or single instance of L2 layer), via the transparent layer 130, in accordance with the defined accelerator function management criteria (and the corresponding group of rules). For instance, the accelerator function manager component 132 can control access to and utilization of the respective accelerator functions (e.g., for baseband processing) by the L2 layer 120, via the transparent layer 130, to achieve desirable (e.g., suitable, acceptable, enhanced, or optimal) resource utilization, energy consumption, communication quality (e.g., QoS, perceived QoS, and/or QoE), other RAN-related performance parameter, and/or overall performance of the RAN 106 based at least in part on (e.g., in accordance with) policies relating to the conditions associated with the RAN 106 and the group of rules that can be created and implemented based on those policies, in accordance with the defined accelerator function management criteria.

In some embodiments, the accelerator function manager component 132, employing the change detector component 206, can determine whether there is a defined threshold change (e.g., a defined threshold amount of change) in the conditions or a defined threshold change in the group of rules, based at least in part on the results of analyzing the conditions associated with the RAN and the group of rules. For instance, the change detector component 206 can determine whether there is the defined threshold amount of change in the conditions or the defined threshold change in the group of rules to facilitate determining whether an accelerator function evaluation is to be initiated or triggered (e.g., determining whether to initiate or trigger a determination of whether to switch from a current accelerator function to another accelerator function being accessed and utilized by the L2 layer 120, via the transparent layer 130, or which accelerator function(s) is to be accessed and utilized by the L2 layer 120, via the transparent layer 130).

In certain embodiments, if, based at least in part on the analysis results, the change detector component 206 determines that the defined threshold amount of change in the conditions and the defined threshold change in the group of rules have not been satisfied (e.g., have not been meet or exceeded; or have not been breached), the change detector component 206 can determine that the accelerator function evaluation is not to be initiated or triggered. In some embodiments, if, instead, based at least in part on the analysis results, the change detector component 206 determines that the amount of change in one or more conditions satisfies (e.g., meets or exceeds; or breaches) the defined threshold amount of change in the conditions and/or the change in the rules satisfies the defined threshold change in the group of rules, the change detector component 206 can determine that the accelerator function evaluation is to be initiated or triggered, in accordance with the defined accelerator function management criteria. Employing the defined threshold change criteria in determining whether to initiate or trigger the accelerator function evaluation can prevent or inhibit an undesirable amount of evaluating accelerator function access by the L2 layer 120 and switching between accessing of accelerator functions by the L2 layer 120, as evaluating accelerator function access and/or switching access of accelerator functions by the L2 layer 120 can utilize resources and/or may cause some delays (e.g., due to switching between accelerator functions), and, also, conditions often can change and rules may change as well, and triggering accelerator function evaluation when there may only be a relatively minor (e.g., small) change in the conditions and/or the group of rules can result in accelerator function evaluation being triggered too often, which may result in any potential benefit from changing accelerator function access by the L2 layer 120 being outweighed by the impact in RAN performance (e.g., can negatively affect QoS, perceived QoS, or QoE, or cause other undesirable RAN performance) due to performing (e.g., too frequently) the accelerator function evaluation and switching between accelerator functions being accessed by the L2 layer 120 (e.g., undesirable toggling between access of accelerator functions by the L2 layer 120).

If the change detector component 206 determines that the amount of change in one or more conditions satisfies the defined threshold amount of change in the conditions and/or the change in the rules satisfies the defined threshold change in the group of rules, and accordingly determines that the accelerator function evaluation is to be initiated or triggered, the accelerator function manager component 132, employing the accelerator function determinator component 208, can perform the accelerator function evaluation to determine whether to switch from the current accelerator function to another accelerator function being accessed and utilized by the L2 layer 120, via the transparent layer 130, or which accelerator function(s) is to be accessed and utilized by the L2 layer 120, via the transparent layer 130, based at least in part on the results of analyzing the conditions and the group of rules (or updated group of rules, if updated) (e.g., by applying the group of rules to the conditions and/or analyzing the conditions in relation to the group of rules).

If, for example, based at least in part on the results of analyzing the conditions and the group of rules (or updated group of rules, if updated), the accelerator function determinator component 208 determines that access, by the L2 layer 120, via the transparent layer 130, is to be switched from one accelerator function (e.g., one of the first accelerator function 126 or the second accelerator function 128) to another accelerator function (e.g., another one of the first accelerator function 126 or the second accelerator function 128), the accelerator function determinator component 208 can select the other accelerator function and switch or facilitate (e.g., initiate or enable) switching access, by the L2 layer 120, via the transparent layer 130, from the one accelerator function to the other accelerator function.

As a non-limiting example, the L2 layer 120 can be accessing, via the transparent layer 130, the first accelerator function 126 associated with the L1 layer 122. If analysis of the conditions indicate that the perceived QoS associated with the L1 layer 122 (e.g., associated with the first accelerator function 126) of the base station 108 is below a defined threshold minimum perceived QoS (e.g., as specified in a rule(s) relating to perceived QoS), and the rule(s) relating to perceived QoS indicates that the perceived QoS is to satisfy (e.g., meet or exceed; or be at or greater than) the defined threshold minimum perceived QoS (e.g., even if more energy or resources associated with the base station 108 have to be utilized), and if, based at least in part on such analysis, the accelerator function determinator component 208 determines that switching access, by the L2 layer 120, via the transparent layer 130, from the first accelerator function 126 to the second accelerator function 128 (e.g., associated with the L1 layer 124) can enable the perceived QoS associated with the base station 108 (e.g., the perceived QoS associated with the L1 layer 124 of the base station 108) to satisfy the defined threshold minimum perceived QoS, in accordance with the rule(s) (and the other rules of the group of rules), the accelerator function determinator component 208 can select the second accelerator function 128 and switch or facilitate switching access, by the L2 layer 120, via the transparent layer 130, from the first accelerator function 126 to the second accelerator function 128.

As another non-limiting example, the L2 layer 120 can be accessing, via the transparent layer 130, the second accelerator function 128 associated with the L1 layer 124. If a rule(s) indicates that it can be desired (e.g., wanted, required, or optimal) for energy (and/or resource) consumption associated with the RAN 106 to be reduced (e.g., provided that the defined threshold minimum QoS (or perceived QoS) can be maintained), and if analysis of the conditions, and evaluation of the respective accelerator functions, indicate that the amount of energy (and/or the amount of resources) utilized by the base station 108 can be desirably reduced (e.g., while maintaining the defined threshold minimum QoS (or perceived QoS)) if access, by the L2 layer 120, via the transparent layer 130, is switched from the second accelerator function 128 to the first accelerator function 126 associated with the L1 layer 122, the accelerator function determinator component 208 can select the first accelerator function 126 and switch or facilitate switching access, by the L2 layer 120, via the transparent layer 130, from the second accelerator function 128 to the first accelerator function 126 (e.g., for baseband processing).

As yet another non-limiting example, during typical daytime working hours on a weekday in an area of a city with a significant number of businesses and people (e.g., employees, customers, and other users) using devices (e.g., mobile or smart phones, electronic tablets, or other devices), the L2 layer 120 can be accessing, via the transparent layer 130, the first accelerator function 126 associated with the L1 layer 122. In this example scenario, the group of rules (e.g., rules relating to duplex type, bandwidth, active spectrum, perceived QoS, time period mapping, and/or other factors or conditions) can indicate that, during typical daytime working hours, it can be desirable to have the L2 layer 120 access, via the transparent layer 130, the first accelerator function 126 associated with the L1 layer 122, and during typical nighttime hours on a weekday when there is usually significantly less people using devices in that area of the city, the group of rules can indicate that it can be desirable to have the L2 layer 120 access, via the transparent layer 130, the second accelerator function 128 associated with the L1 layer 124, based at least in part on the mapping of respective accelerator functions to respective time periods, as indicated by the time period mapping rule (e.g., because doing so can desirably reduce energy and resource consumption during the nighttime period). If analysis of the conditions (e.g., time of day or other conditions) indicate that it is the nighttime period on a weekday (e.g., and if the analysis indicates that there is no overriding condition or rule that can supersede the time-of-day condition and the time period mapping rule), the accelerator function determinator component 208 can determine that switching access, by the L2 layer 120, via the transparent layer 130, from the first accelerator function 126 to the second accelerator function 128 can be desirable (e.g., to reduce energy and resource consumption during the nighttime period), in accordance with the time period mapping rule (and/or other applicable rule(s) of the group of rules). Accordingly, the accelerator function determinator component 208 can select the second accelerator function 128, and can switch or facilitate switching access, by the L2 layer 120, via the transparent layer 130, from the first accelerator function 126 to the second accelerator function 128 associated with the L1 layer 124.

As still other non-limiting examples, the L2 layer 120 can be accessing, via the transparent layer 130, the first accelerator function 126 associated with the L1 layer 122. The group of rules (e.g., rules relating to hardware faults or interruptions, software faults or interruptions, maintenance events, and/or upgrade events) can indicate that, if there is a hardware fault or interruption, software fault or interruption, maintenance event, and/or upgrade event associated with an L1 layer (e.g., L1 layer 122), or an accelerator function (e.g., accelerator function 126), other component, or other function associated therewith, access, by the L2 layer 120, via the transparent layer 130, is to be transitioned (e.g., switched) from that accelerator function to another accelerator function (e.g., accelerator function 128) associated with another L1 layer (e.g., L1 layer 124). Accordingly, if the analysis of the conditions indicates that there is a hardware fault or interruption, software fault or interruption, maintenance event, and/or upgrade event associated with the L1 layer (e.g., L1 layer 122), or the accelerator function (e.g., accelerator function 126), other component, or other function associated therewith, the accelerator function determinator component 208 can determine that transitioning access, by the L2 layer 120, via the transparent layer 130, from that accelerator function (e.g., 126) to the other accelerator function (e.g., 128) can be desirable (e.g., to maintain connectivity and services for devices associated with the base station 108), in accordance with the group of rules. Accordingly, the accelerator function determinator component 208 can select the other accelerator function (e.g., 128), and can transition or facilitate transitioning access, by the L2 layer 120, via the transparent layer 130, from the current accelerator function (e.g., 126) to the other accelerator function (e.g., 128) associated with the other L1 layer (e.g., 124).

It is to be appreciated and understood that, in some instances (e.g., in some scenarios, under some conditions and rules), depending in part on the conditions and the group of rules, the accelerator function determinator component 208 may determine that, even though the accelerator function evaluation was triggered, access, by the L2 layer 120, via the transparent layer 130, is not to be switched from one (e.g., the current) accelerator function (e.g., one of the first accelerator function 126 or the second accelerator function 128) to the other accelerator function (e.g., the other one of the first accelerator function 126 or the second accelerator function 128). For instance, the accelerator function determinator component 208 may determine that, while the conditions associated with the RAN 106 may not be desirable with the L2 layer 120 accessing the current accelerator function, the conditions associated with the RAN 106 are expected to be worse (or at least not better) if access, by the L2 layer 120, via the transparent layer 130, is switched from the current accelerator function to the other accelerator function. Accordingly, the accelerator function determinator component 208 can determine that the L2 layer 120 is to continue accessing and utilizing the current accelerator function.

It also is to be appreciated and understood that, in certain instances (e.g., in certain scenarios, under certain conditions and rules), depending in part on the conditions and the group of rules, the accelerator function determinator component 208 can determine that it can be desirable (e.g., wanted, suitable, or optimal) to have the L2 layer 120 access (e.g., access concurrently, simultaneously, or in parallel), via the transparent layer 130, two (or more) accelerator functions (e.g., first accelerator function 126 and second accelerator function 128). As a non-limiting example, the base station 108 can be located in an area near where an event is going to be held, where there is expected to be a large number of devices being used by users. As a result, it can be desirable to have the base station 108 be able to have sufficient bandwidth, active spectrum, and QoS (e.g., QoS and/or perceived QoS) to provide desirable connectivity and services (e.g., voice and data services, and/or other services) to the devices during the event. The group of rules (e.g., one or more rules of the group of rules) can indicate that, under such conditions, it can be desirable (e.g., wanted, suitable, or optimal) to have the L2 layer 120 access (e.g., access concurrently, simultaneously, or in parallel), via the transparent layer 130, two (or more) accelerator functions. Accordingly, during the event, when such conditions are detected by the accelerator function manager component 132, the accelerator function determinator component 208 can determine that the L2 layer 120 access (e.g., access concurrently, simultaneously, or in parallel), via the transparent layer 130, two (or more) accelerator functions (e.g., first accelerator function 126 and second accelerator function 128), based at least in part on such conditions and the group of rules.

In some embodiments, the accelerator function manager component 132 can apply respective weights to respective rules of the group of rules (or respective conditions) based at least in part on respective significance (e.g., respective priority or importance) of the respective rules (or the respective conditions), in accordance with the defined accelerator function management criteria. For instance, the accelerator function manager component 132 can apply a first weight to a first rule, a second weight to a second rule, and another weight(s) to another rule(s), of the group of rules, wherein the first weight can be higher than the second weight due to the first rule having a relatively higher significance than the second rule in determining which accelerator function is to be accessed by the L2 layer 120 under certain conditions associated with the RAN 106. In certain embodiments, the accelerator function manager component 132 can apply respective weights to the respective rules based at least in part on the time period mapping. That is, the time period mapping can map respective accelerator functions, respective rules (or respective conditions), respective weights (e.g., respective weight values), and respective time periods to each other. For example, during a first time period (e.g., daytime period during typical weekday work day in a business/commerce area), the accelerator function manager component 132 can apply the first weight to the first rule, the second weight to the second rule, and another weight(s) to another rule(s), of the group of rules, wherein the first weight can be higher than the second weight due to the first rule having a relatively higher significance than the second rule in determining which accelerator function is to be accessed by the L2 layer 120 under certain conditions associated with the RAN 106. However, during a second time period (e.g., nighttime period during typical weekday work day when there can be significantly fewer devices accessing the base station 108 than during the daytime period), the accelerator function manager component 132 can apply a third (or the second) weight to the first rule, a fourth (or the first) weight to the second rule, and another disparate weight(s) to the other rule(s), of the group of rules, wherein the fourth (or the first) weight can be higher than the third (or the second) weight due to the second rule having a relatively higher significance than the first rule in determining which accelerator function is to be accessed by the L2 layer 120 under certain conditions associated with the RAN 106.

With further regard to the interactions between the L2 layer 120, in some embodiments, the transparent layer 130, the L1 layer 122, and the L1 layer 124, the L2 layer 120 can communicate downlink data to the transparent layer 130, via an interface 220 (e.g., a MAC-to-PHY (MAC2PHY) interface), for forwarding to the L1 layer 122 or the L1 layer 124. The L2 layer 120 can receive uplink data from the transparent layer 130, via an interface 222 (e.g., a PHY-to-MAC (PHY2MAC) interface), for forwarding to or towards the core network 104 or other destination (e.g., other next destination node). The transparent layer 130 can transmit downlink data to the L1 layer 122, via an interface 224 (e.g., a MAC2PHY interface), for forwarding to or towards the fronthaul (e.g., the RU 118) or other destination (e.g., other next destination node), via an interface 226. The transparent layer 130 also can receive uplink data from the L1 layer 122, via an interface 228 (e.g., a PHY2MAC interface), for forwarding (e.g., communicating) to the L2 layer 122. Similarly, the transparent layer 130 can transmit downlink data to the L1 layer 124, via an interface 230 (e.g., a MAC2PHY interface), for forwarding to or towards the fronthaul (e.g., the RU 118) or other destination (e.g., other next destination node), via an interface 232. The transparent layer 130 also can receive uplink data from the L1 layer 124, via an interface 234 (e.g., a PHY2MAC interface), for forwarding to the L2 layer 124.

In certain embodiments, the DU 116 can be associated with one or more cells of the base station 108. For instance, a first group of cells 236, comprising one or more cells, can be associated with the L1 layer 122, the first accelerator function 126, the transparent layer 130, and the L2 layer 120, and a second group of cells 238, comprising one or more cells (e.g., one or more other cells), can be associated with the L1 layer 124, the second accelerator function 128, the transparent layer 130, and the L2 layer 120. In some embodiments, at any point in time, a cell (e.g., cell of the first group of cells 236) can be activated on a single L1 layer (e.g., L1 layer 122) only, which can mean that the L2 layer 120 can communicate with that single L1 layer for that cell (e.g., via the transparent layer 130). For instance, the L2 layer 120 can access the respective accelerator functions (e.g., first accelerator function 126, second accelerator function 128, and/or another accelerator function) through the transparent layer 130, where each cell (e.g., each cell of the first group of cells 236, and each cell of second group of cells 238) can be associated with (e.g., linked or tied to) a single L1 layer (e.g., either L1 layer 122 or L1 layer 124) only.

In some embodiments, the accelerator function manager component 132, the transparent layer 130, and the enhanced techniques relating to accelerator function management described herein can desirably (e.g., suitably, efficiently, enhancedly, or optimally) solve dynamic cells distribution over different L1 acceleration (e.g., different accelerator functions), while enhancing (e.g., improving or optimizing) energy consumption (e.g., reducing or minimizing energy consumption) and resiliency for one or more cells (e.g., one or more cells of the first group of cells 236 and/or the second group of cells 238) of the RAN 106. As a non-limiting example, the DU 116 can be associated with (e.g., can support) sub-3 gigahertz (GHz) cells, which also can be referred to as sub-3 cells, and sub-6 GHz cells, which also can be referred to as sub-6 cells. In certain embodiments, the transparent layer 130 and/or the accelerator function manager component 132 can schedule light-weight cells (e.g., lower band sub-3 cells) on the processor component (e.g., CPU or other processor) with look-aside acceleration and heavy-weight cells (e.g., midband sub-6 cells) or low latency cells (e.g., midband sub-6 cells or millimeter wave (mmwave) cells) with inline acceleration. For instance, the first group of cells 236 can comprise the light-weight cells (e.g., lower band sub-3 cells), which can be associated with the L1 layer 122 and the first accelerator function 126 (e.g., look-aside accelerator function); and the second group of cells 238 can comprise the heavy-weight cells (e.g., midband sub-6 cells) or the low latency cells (e.g., midband sub-6 cells or millimeter wave cells), which can be associated with the L1 layer 124 and the second accelerator function 128 (e.g., inline accelerator function).

As another non-limiting example, the DU 116 can be associated with (e.g., can support) frequency division duplexing (FDD) cells, and time division duplexing (TDD) cells. In some embodiments, the transparent layer 130 and/or the accelerator function manager component 132 can schedule the FDD cells with look-aside acceleration and the TDD cells with inline acceleration. For instance, the first group of cells 236 can comprise the FDD cells, which can be associated with the L1 layer 122 and the first accelerator function 126 (e.g., look-aside accelerator function); and the second group of cells 238 can comprise the TDD cells, which can be associated with the L1 layer 124 and the second accelerator function 128 (e.g., inline accelerator function). It is to be appreciated and understood that these are non-limiting examples, and the first group of cells 236 and the second group of cells 238 can comprise other arrangements, allocations, or mixtures of respective cells (e.g., respective types of cells, such as sub-3 cells, sub-6 cells, mmwave cells, FDD cells, TDD cells, or other type of cells).

As disclosed, in some embodiments, the transparent layer 130 can be fully agnostic to the L2 layer 120 and the L1 layers (e.g., 122 and 124). In certain embodiments, the respective accelerator functions (e.g., 126 and 128) typically may not be working in tandem, but rather only one accelerator function can be associated with a single cell, and so the accelerator function and the single cell can be isolated from the other accelerator function(s). In some embodiments, the accelerator function manager component 132 and/or the transparent layer 130 can determine (e.g., decide) which cell can be activated on which L1 layer (e.g., 122 or 124) and associated accelerator function (e.g., 126 or 128), and when such cell can be activated on the selected L1 layer, based at least in part on the group of rules (e.g., accelerator function management policies incorporated or reflected in the group of rules) and the conditions associated with the RAN 106, in accordance with the defined accelerator function management criteria.

It is noted that there typically can be latencies in uplink communications and downlink communications associated with cells. In some embodiments, the transparent layer 130, which can be situated between the L2 scheduler (e.g., L2 MAC scheduler) and the L1 layers (e.g., 122 and 124), also potentially can introduce additional latencies uplink communications and downlink communications associated with cells. The L2 scheduler of the L2 layer 120 has to be responsible for compensating the additional L1 latencies associated with the transparent layer 130 on scheduling transport blocks (TB) in advance depending in part on how well the additional latencies can fit within the integral multiple of TTI of the cell. Normally, the L2 scheduler of the L2 layer 120 can schedule the TBs within the integral multiple of TTI (e.g., 1×TTI, 2×TTI, 3×TTI, 4×TTI, and so on) depending in part on the cell configurations, L1 latencies and jitters, QoS and channel conditions, and/or other conditions or factors. The L2 scheduler can adopt to a desirable (e.g., wanted, suitable, or optimal) integral multiple of TTI on scheduling the TBs.

In some embodiments, the L2 scheduler of the L2 layer 120 can incorporate the latency compensation, which can compensate for the additional latencies that can be associated with the transparent layer 130, in accordance with some logical or mathematical models, such as follows. In that regard, it is assumed that Lₗₐ can be maximum look-aside L1 latency in microseconds and Lᵢₙ can be maximum inline L1 latency in microseconds. Jₗₐ can be additional latency introduced for look-aside L1 and Jᵢₙ can be additional latency introduced for inline L1 by the transparent layer 130. In certain embodiments, the L2 scheduler of the L2 layer 120 can employ and follow (e.g., ensure scheduling TBs in accordance with) the equations below, while scheduling TBs for a cell with Tₗₐ (TTI) microseconds for look-aside L1 and Tᵢₙ (TTI) microseconds for inline L1.

For instance, with regard to look-aside L1 (e.g., when the look-aside accelerator function is being accessed and utilized by the L2 layer 120 via the transparent layer 130), the L2 scheduler can schedule TBs for a cell with Tₗₐ (TTI) microseconds for look-aside L1, in accordance with the following equations:
Lₗₐ+Jₗₐ desirably can be (e.g., should be) less than the closest multiple of Tₗₐ (TTI) microseconds; and

$$( {L}_{la} + {J}_{la} ) \frac{100}{{T}_{la}} \leq N * 100 ,$$

where N can be an integer, such as 1, 2, 3, 4, and so on.

As another example, with regard to inline L1 (e.g., when the inline accelerator function is being accessed and utilized by the L2 layer 120 via the transparent layer 130), the L2 scheduler can schedule TBs for a cell with Tᵢₙ (TTI) microseconds for inline L1, in accordance with the following equations:
Lᵢₙ+Jᵢₙ can be (e.g., should be) less than the closest multiple of Tᵢₙ (TTI) microseconds; and

$$( {L}_{in} + {J}_{i n} ) \frac{100}{{T}_{i n}} \leq N * 1 \; 00 ,$$

where N can be an integer, such as 1, 2, 3, 4, and so on.

These conditions can assist or aid the L2 scheduler to offset any additional latencies that may be introduced by the transparent layer 130, so that the schedules of the TBs can remain desirably (e.g., suitably or optimally) in advance. It is noted that, based on the advancements in silicon related to single instructions, multiple data (SIMD), such as AVX512 and advance matrix extension (AMX), such advancements can assist or aid in compensating the additional latencies if introduced by the transparent layer 130.

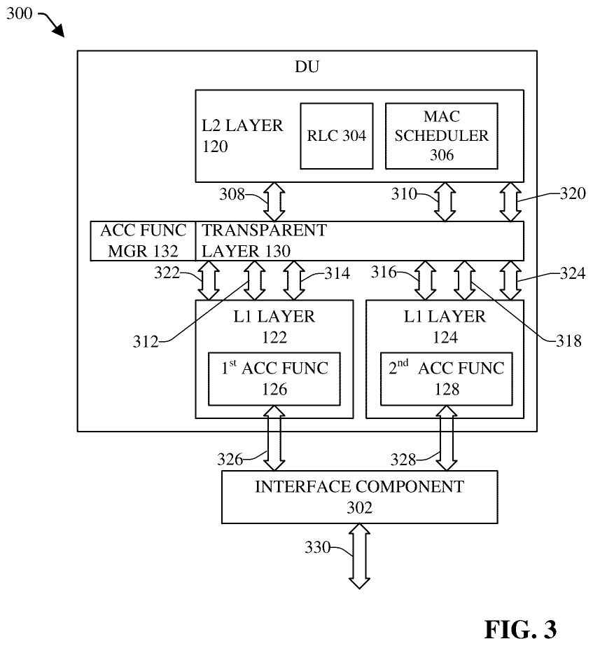

Referring to FIG. 3 (along with FIGS. 1 and 2), FIG. 3 illustrates a block diagram of a non-limiting example DU 300 that can comprise the transparent layer 130 and the accelerator function manager component 132 that can manage access by the L2 layer to multiple accelerator functions, via respective dedicated channels that can be associated with respective accelerator functions, in accordance with various aspects and embodiments of the disclosed subject matter. In certain embodiments, the DU 300 can be a single DU function in a disaggregated RAN (e.g., RAN 106). In some embodiments, the DU 300 can comprise the L2 layer 120, the L1 layer 122, the L1 layer 124, the first accelerator function 126, the second accelerator function 128, the transparent layer 130, the accelerator function manager component 132, and an interface component 302, such as described herein. In certain embodiments, the interface component 302 can be a network interface card (NIC), such as a single root input/output virtualization (SR-IOV) enabled NIC, or other desired type of interface component that can enable connection to the network and communication of data from and to the DU 300. In accordance with various embodiments, the L2 layer 120 can comprise a radio link control (RLC) 304 and a MAC scheduler 306 (also referred to as an L2 scheduler or L2 MAC scheduler). In some embodiments, the first accelerator function 126 can be a look-aside accelerator function, and the second accelerator function 128 can be an inline accelerator function, although, in other embodiments, the first accelerator function 126 and/or the second accelerator function 128 can be other (e.g., different) types of accelerator functions.

In some embodiments, as disclosed, the transparent layer 130 can be transparent to both the L2 layer 120 and the respective L1 layers (e.g., 122 and 124). In certain embodiments, the transparent layer 130 and associated accelerator function manager component 132 can build intelligence and knowledge for managing access to the respective accelerator functions (e.g., 126 and 128) based at least in part on current conditions of logical transport channels and intercepting the hardware alarms, including peripheral component interconnect express (PCIe) cards, and based at least in part on the group of rules. In some embodiments, the transparent layer 130 and the accelerator function manager component 132 can manage (e.g., control) access by the L2 layer 120 to the respective accelerator functions (e.g., 126 and 128), via respective dedicated channels that can be associated with the respective accelerator functions (e.g., via the respective dedicated channels to the respective accelerator functions). In certain embodiments, the transparent layer 130 can operate (e.g., run) in the processor component (e.g., CPU or other processor) and does not have to depend on any external hardware. The transparent layer 130 can desirably enhance (e.g., intelligently and efficiently improve or optimize) the use of L1 resources, including the respective accelerator functions (e.g., 126 and 128), to process baseband packets to and from the relevant RU (e.g., RU 118 and/or other RU associated with the DU 300). The transparent layer 130 and/or the accelerator function manager component 132 can comprise or can access the group of rules to enhance the use of cells of the DU 300 based at least in part on current channel conditions along with enhancing (e.g., improving or optimizing) the energy consumption (e.g., reduce or minimize energy consumption) of or associated with the DU 300.

In accordance with various embodiments, the L2 layer 120 (e.g., L2 (MAC and Scheduler) layer) can communicate with the L1 layers 122 and 124 (e.g., L1 (High PHY) layers), via the transparent layer 130, using interfaces 308, 310, 312, 314, 316, and/or 318. In some embodiments, the interfaces 308, 310, 312, 314, 316, and/or 318 can be femtocell application programming interface (FAPI) P5 and P7 interfaces. In other embodiments, the interfaces 308, 310, 312, 314, 316, and/or 318 can be a different type of interface. The transparent layer 130 situated between the L2 layer 120 and the respective L1 layers 122 and 124 can process the information (e.g., messages) passed to and from the L2 layer 120 and respective L1 layers 122 and 124 using the respective interfaces 308, 310, 312, 314, 316, and/or 318 (e.g., the P5 and P7 interfaces and/or communication links). The accelerator function manager component 132 and/or the transparent layer 130 can evaluate the appropriate L1 layer of the respective L1 layers (e.g., 122 or 124), and can propagate the proprietary information of the L1 vendor to the selected L1 accelerator function (e.g., 126 or 128), if desired (e.g., wanted or required). In certain embodiments, the transparent layer 130 also may not be agnostic to the proprietary information of the L1 vendor in some cases, depending in part on the design of L1, so the transparent layer 130 and/or the accelerator function manager component 132 can handle it with desirable care and proper translation of TTI schedules before invoking the selected L1 accelerator function. If the L1 accelerator functions are from the same vendor, the implementation of the transparent layer 130 and/or the accelerator function manager component 132 may be, or at least potentially may be, less complex and more transparent. It can be desirable for the proprietary information of the vendor to be handled transparently as part of implementing the transparent layer 130 and/or the accelerator function manager component 132 for both downlink and uplink messaging. It also can be desirable for the transparent layer 130 and/or the accelerator function manager component 132 to work strictly under the limited latency budget, otherwise TTI schedule may be re-attempted by the L2 layer 120, which may cause an adverse impact on the overall QoS and KPIs of the wireless service.

In accordance with various embodiments, respective interfaces 320, 322, and 324 can be utilized to communicate the management configurations to either or both of the L1 accelerator functions (e.g., 126 and/or 128), to whichever accelerator function the configuration applies. In some embodiments, the respective interfaces 320, 322, and 324 can be FAPI P2 interfaces. In other embodiments, the interfaces 320, 322, and/or 324 can be a different type of interface.

In certain embodiments, the L1 layers (e.g., 122 and/or 124) and/or the associated accelerator functions (e.g., 126 and/or 128) can communicate downlink data to or can receive uplink data from the interface component 302 via respective interfaces 326 and/or 328. In some embodiments, the respective interfaces 326 and 328 can be virtual function (VF) interfaces. In other embodiments, the interfaces 326 and/or 328 can be a different type of interface. The interface component 302 can communicate downlink data to or can receive uplink data from an RU (e.g., RU 118) via an interface 330 (e.g., fronthaul interface).

In accordance with various embodiments, the accelerator function manager component 132 and/or the transparent layer 130 can handle the following operations to facilitate providing as resilient binding between the L2 layer 120 and the respective L1 accelerator functions (e.g., 126 and 128) with different acceleration architectures and functions known as look-aside acceleration and inline acceleration. With regard to downlink messages processing and the selection of the desired (e.g., appropriate, wanted, suitable, or optimal) L1 accelerator function, the accelerator function manager component 132 and/or the transparent layer 130 can handle and perform the following operations:
1. The transparent layer 130 and/or the accelerator function manager component 132 can initialize itself or themselves and can communicate with the respective L1 accelerator functions (e.g., 126 and 128).
2. The transparent layer 130 and/or the accelerator function manager component 132 can evaluate the configuration and the states of the respective L1 accelerator functions (e.g., 126 and 128).
3. The transparent layer 130 and/or the accelerator function manager component 132 can enable either, both, or a specific L1 accelerator function (e.g., 126 and/or 128) based at least in part on the group of rules and the current conditions of the accelerator functions and/or the RAN 106.
4. The transparent layer 130 and/or the accelerator function manager component 132 can enable communication links with the respective L1 accelerator functions (e.g., 126 and 128) for both downlink and uplink messaging.
5. Once the transparent layer 130 receives the cells setup information from the L2 layer 120 during the cells initialization, the transparent layer 130 and/or the accelerator function manager component 132 can propagate the cells initialization to the one or more selected L1 accelerator functions (e.g., 126 and/or 128) depending in part on actions taken by operations 3 and 4.
6. Once the cells come up, the control and user planes information can be passed to the communication links (e.g., P5 and P7 interfaces) with appropriate proprietary information (e.g., of the vendor) of the L1 accelerator function(s) (e.g., 126 and/or 128).

With regard to uplink messages coming from the L1 accelerator functions, the accelerator function manager component 132 and/or the transparent layer 130 can handle and perform the following operations:
1. After the L1 accelerator functions (e.g., 126 and 128) are initialized, the transparent layer 130 can receive the uplink messages, via the communication links, from the enabled L1 accelerator function(s) (e.g., 126 and/or 128).
2. The transparent layer 130 and/or the accelerator function manager component 132 can process the uplink messages and remove the proprietary information of the vendor before communicating the uplink messages to the L2 layer 120.

With further regard to FIGS. 1 and 2 and the processor component 210 and the data store 212, the processor component 210 can be associated with (e.g., communicatively connected to) and can work in conjunction with other components of the accelerator function manager component 132, including the condition evaluator component 202, the rule component 204, the change detector component 206, the accelerator function determinator component 208, the data store 212, the AI component 214, and/or other components of the accelerator function manager component 132 or the RAN 106, to facilitate performing the various functions and operations of the accelerator function manager component 132. The processor component 210 can employ one or more processors (e.g., one or more CPUs), accelerators, graphics processing units (GPUs), application-specific integrated circuits (ASICs), microprocessors, controllers, microcontrollers, or other processors) that can process information relating to data (e.g., user data or other data), files, services, applications, RANs, cells, communication network, core network, devices, users, data traffic, communication sessions (e.g., PDU or other communication sessions), condition or measurement reports, accelerator functions, the transparent layer, rules, L2 layer, L1 layers, vendor information, AI/machine learning (ML)-based models, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined accelerator function management criteria, algorithms (e.g., enhanced accelerator function management algorithms, AI algorithms, hash algorithms, data compression algorithms, data decompression algorithms, and/or other algorithm), interfaces, protocols, tools, and/or other information, to facilitate operation of the accelerator function manager component 132 and/or the RAN 106, and control data flow between the accelerator function manager component 132 and/or other components (e.g., network equipment, components, or functions, the communication network 102, the core network 104, another base station, a device (e.g., 110 or 112), a node, an application, a service, a user, or other entity) associated with the accelerator function manager component 132.

The data store 212 can store data structures (e.g., user data, metadata), code structure(s) (e.g., modules, objects, hashes, classes, procedures) or instructions, information relating to data, files, services, applications, RANs, cells, communication network, core network, devices, users, data traffic, communication sessions (e.g., PDU or other communication sessions), condition or measurement reports, accelerator functions, the transparent layer, rules, L2 layer, L1 layers, vendor information, AI/ML-based models, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined accelerator function management criteria, algorithms (e.g., enhanced accelerator function management algorithms, AI algorithms, hash algorithms, data compression algorithms, data decompression algorithms, and/or other algorithm), interfaces, protocols, tools, and/or other information, to facilitate controlling or performing operations associated with the accelerator function manager component 132 and/or the RAN 106. The data store 212 can comprise volatile and/or non-volatile memory, such as described herein. In an aspect, the processor component 210 can be functionally coupled (e.g., through a memory bus) to the data store 212 in order to store and retrieve information desired to operate and/or confer functionality, at least in part, to the condition evaluator component 202, the rule component 204, the change detector component 206, the accelerator function determinator component 208, the data store 212, the AI component 214, and/or other component of the accelerator function manager component 132, and/or substantially any other operational aspects of the accelerator function manager component 132.

With further regard to the AI component 214, in accordance with various embodiments, the AI component 214 and/or the model 218 can perform an AI-based analysis on data, such as information relating to communication sessions, data traffic, applications, services, attributes, conditions, rules, the RAN 106, accelerator functions (e.g., 126 and 128), the transparent layer 130, the L2 layer 120, the L1 layers 122 and 124, operations, functions, parameters, events, and/or other features associated with the RAN 106 and/or devices (e.g., device 110 and/or device 112), and/or the core network 104, and/or feedback information (e.g., feedback information from a user, a device, a base station (e.g., base station 108), network equipment or network function of the core network 104, or another data source). In some embodiments, with regard to a model 218, the AI component 214 can input such information into the (trained) model 218 for analysis (e.g., AI-based analysis) by the model 218 to update the model 218 or to generate output results (e.g., AI-related output result data relating to management and selection of accelerator functions, and/or other output results) based at least in part on the analysis of the input information.

In connection with or as part of such an AI-based analysis, the AI component 214 can employ, build (e.g., construct or create), and/or import, AI-based techniques and algorithms, AI-based models 218 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns of conditions associated with the RAN 106 and/or the devices, determining or learning about patterns of selection and use of the respective accelerator functions (e.g., 126 and/or 128) in relation to the group of rules and the conditions associated with the RAN 106 and/or devices, determining or learning about data traffic associated with communication sessions between the RAN 106 and devices (e.g., 110 or 112), performing other desired functions or operations, and/or automating one or more functions or features of the disclosed subject matter, as more fully described herein.

The AI component 214 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 214 can examine the entirety or a subset of the data (e.g., the training data; the operational data relating to the communication network 102, the core network 104, a device (e.g., device 110 and/or device 112), the RAN 106, a base station (e.g., base station 108), the L2 layer 120, the L1 layers 122 and 124, the accelerator functions 126 and 128, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 214 and/or the trained model(s) 218 can employ one or more threshold probabilities (e.g., threshold probability values) to facilitate making a determination. For instance, in making a determination (e.g., a determination of whether to select the look-aside accelerator function, the inline accelerator function, or both, for access by the L2 layer 120 via the transparent layer 130), as part of the AI-based analysis of information, the AI component 214 and/or the trained model(s) 218 can determine a probability (e.g., a probability that a particular accelerator function(s) is the most desirable accelerator function(s) to select for access by the L2 layer 120, or other probability), and can determine whether the probability (e.g., probability value) satisfies (e.g., meets or exceeds; or is at or greater than) a defined and applicable threshold probability. The AI component 214 and/or the trained model(s) 218 can make a determination (or prediction or inference) (e.g., a determination (or prediction or inference) of whether to select the look-aside accelerator function, the inline accelerator function, or both accelerator functions, for access by the L2 layer 120 via the transparent layer 130, or other determination) based at least in part on the results of analyzing (e.g., comparing) the probability to the defined and applicable threshold probability (e.g., threshold minimum probability value). As a non-limiting example, the AI component 214 and/or the trained model(s) 218 can make a determination (or prediction or inference) that a particular accelerator function(s) (e.g., the look-aside accelerator function, the inline accelerator function, or both) is the most desirable accelerator function(s) to select for access by the L2 layer 120 based at least in part on determining that a probability that the particular accelerator function(s) is the most desirable accelerator function(s) to select for access by the L2 layer 120 satisfies the defined and applicable threshold probability (e.g., the probability is the highest probability, relative to other probabilities relating to whether the particular accelerator function(s) is the most desirable accelerator function(s) to select for access by the L2 layer 120, and satisfies the defined and applicable threshold probability). In other embodiments, the AI component 214 and/or the trained model(s) 218 can make a determination (or prediction or inference) that the particular accelerator function(s) is the most desirable accelerator function(s) to select for access by the L2 layer 120 based at least in part on determining that a probability that the particular accelerator function(s) is the most desirable accelerator function(s) to select for access by the L2 layer 120 is a highest probability relative to the other probabilities (e.g., a probability that another accelerator function is the most desirable accelerator function to select for access by the L2 layer 120), without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 214 can employ a classifier that can perform an AI-based analysis on data. A classifier can map an input attribute vector, z=(z1, z2, z3, z4, . . . , zn), to a confidence that the input belongs to a class, as by f(z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 214 (e.g., employing the trainer component 216) can comprise, generate, and/or train (e.g., iteratively train) AI-based models 218 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., L2 layer 120, transparent layer 130, L1 layer 122 and 124, accelerator functions 126 and 128, RAN 106, cells, network nodes, communication links, devices, or other components or functions) of or associated with the communication network 102; patterns relating to data traffic (e.g., type of data traffic, amount of data traffic, or other characteristic of data traffic) associated with communication sessions between the RAN 106 station and devices (e.g., device 110 and/or device 112, utilizing an application or service); patterns of conditions associated with the RAN 106 and/or the devices; and/or patterns of selection and use of the respective accelerator functions (e.g., 126 and/or 128) in relation to the group of rules and the conditions associated with the RAN 106 and/or devices; and/or to perform other desired functions or operations, and/or to automate one or more functions or features of the disclosed subject matter, as described herein.

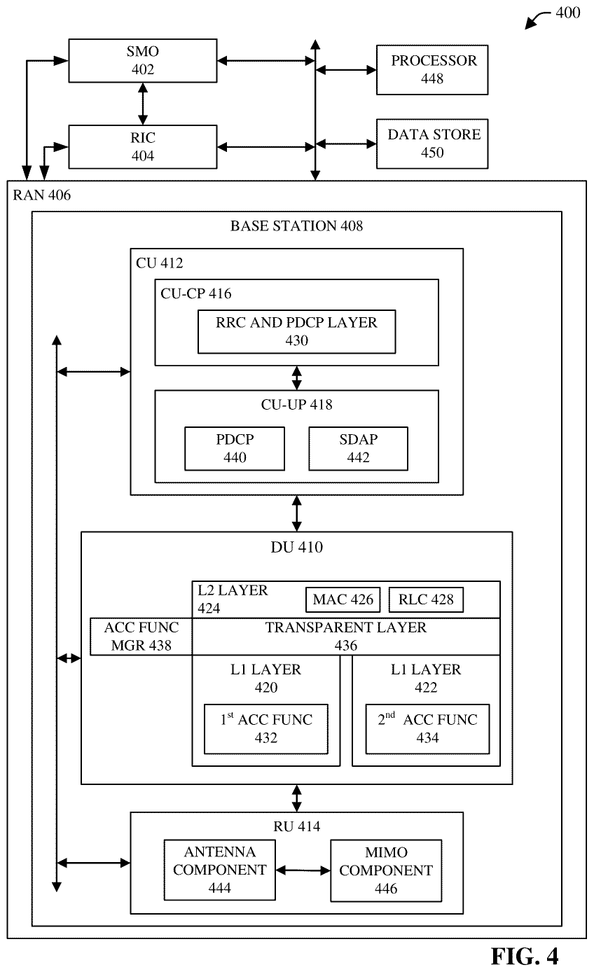

Turning to FIG. 4 (along with FIGS. 1 and 2), FIG. 4 depicts a block diagram of non-limiting example system 400 that can comprise the transparent layer and the accelerator function manager component in the RAN in an O-RAN communication network environment to facilitate desirable (e.g., suitable, reliable, efficient, enhanced, and/or optimal) management and performance of access and utilization of respective accelerator functions of respective L1 layers by the L2 layer, via the transparent layer, of the RAN, in accordance with various aspects and embodiments of the disclosed subject matter. In some embodiments, the system 400 can be part of the system 100 depicted in FIG. 1.

The system 400 can comprise a service management and orchestration (SMO) 402, a RIC 404, and the RAN 406. In some embodiments, the RAN 406 can be an O-RAN that can be part of an O-RAN architecture and environment (e.g., the communication network 102 can employ an O-RAN architecture and environment). In certain embodiments, the RAN 406 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 406 may not be an O-RAN, C-RAN, or vRAN.

In accordance with various embodiments, the RAN 406 and associated communication network (e.g., communication network 102) can be part of a 5G or other new radio (NR) communication environment (e.g., an xG communication environment, wherein x can be 5 or a number greater than 5). In some embodiments, with regard to 5G or other NR generation, the RAN 406 can comprise base stations, such as a gNodeB (gNB or NR-NB), that can be disaggregated into a CU (e.g., gNB or other NR-NB CU), comprising a CU-user plane (CU-UP) (e.g., gNB or other NR-NB CU-UP), a CU-control plane (CU-CP) (e.g., gNB or other NR-NB CU-CP), and a DU (e.g., gNB or other NR-NB DU). The CU-UP and DU can be part of the user plane node, with the CU-UP hosting packet data convergence protocol (PDCP) and service data adaptation protocol (SDAP) entities, and the DU can host the RLC, MAC, and PHY layers. For instance, the RAN 406 can comprise the base station 408 that can comprise a DU 410, a CU 412, and an RU 414 (e.g., a gNB or other NR-NB RU). The CU 412 can comprise a CU-CP 416 (also referred to as a CU-CP node) and a CU-UP 418 (also referred to as a CU-UP node). In certain embodiments, the RAN 406 and/or the base station 408 can comprise multiple DUs, multiple CU-CPs, multiple CU-UPs, and/or multiple RUs. In some embodiments, the DU 410, the CU 412, and the RU 414 can be co-located at a cell site. In other embodiments, the RAN 406 can be a disaggregated RAN where one or more of the components (e.g., the CU 412, or at least part of the CU 412, such as the CU-CP 416) of the base station 408 can be located in different location than one or more other components (e.g., DU 410, RU 414, and/or CU-UP 418) of the base station 408.

The DU 410 can be a logical node that can host or handle baseband (e.g., PHY) functionality, using L1 layers 420 and 422, and L2 functionality, using L2 layer 424, which can comprise a MAC layer 426 and an RLC layer 428, associated with the base station 408. The CU-CP 416 can be a logical node that can host or handle layer 3 (L3) (e.g., an RRC and packet data convergence protocol (PDCP) layer 430) control plane functionality associated with the base station 408. In certain embodiments, the L1 layer 420 can comprise or be associated with the first accelerator function 432 (e.g., look-aside accelerator function), and the L1 layer 422 can comprise or be associated with the second accelerator function 434 (e.g., inline accelerator function), such as described herein.

In some embodiments, the system 400 also can comprise or be associated with the transparent layer 436 and the accelerator function manager component 438 that part of or can be associated with the DU 410 and/or other components of the RAN 406. The transparent layer 436 and the accelerator function manager component 438 can comprise various respective components and functions, and can perform various respective operations, such as described herein. In certain embodiments, the accelerator function manager component 438 can desirably manage access (e.g., concurrent, simultaneous, or parallel access, and/or transparent access) and utilization of the respective accelerator functions (e.g., 432, 434) associated with the respective L1 layers (e.g., 420, 422) by the L2 layer 424 (e.g., a single L2 layer or single instance of L2 layer), via the transparent layer 436, in accordance with the defined accelerator function management criteria, such as described herein.

In certain embodiments, the CU-UP 418 can be a logical node that can host or handle data traffic between the core network 104 (e.g., 5G core network) and one or more DUs (e.g., the DU 410) to which the CU-UP 418 is connected. In some embodiments, the CU-UP 418 can comprise a PDCP component (PDCP) 440 that can perform PDCP functions, and an SDAP component (SDAP) 442 that can perform SDAP functions.

In some embodiments, the RU 414 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 406 and other devices (e.g., devices 110 and/or 112) or components (e.g., components or functions of the core network 104 or communication network 102). In some embodiments, the RU 414 can comprise an antenna component 444 that can comprise an antenna array that can comprise a desired number of transmitter and receiver antennas to facilitate transmission and receiving of signals comprising information, and perform various beamforming, antenna-related, and communication-related functions. The RU 414 also can comprise a MIMO component 446 that can be employed to generate or modify a number of MIMO spatial layers and a number of spatial streams employed by the base station 408 (e.g., with regard to a device(s)) during a communication session between the base station 408 and a device (e.g., device 110), and perform MIMO spatial multiplexing functions. In certain embodiments, the MIMO component 446 can be configured in a single user (SU)-type MIMO mode or a multiple user (MU)-type MIMO mode. In some embodiments, the MIMO component 446 can employ or support massive MIMO (mMIMO). The RU 414 also can comprise or be associated with other functions, including, for example, modulation and coding scheme (MCS) functions and transmit diversity functions.

In some embodiments, as disclosed, the system 400 can comprise an O-RAN architecture and environment, and the RAN 406 can be an O-RAN. In some embodiments, in the O-RAN architecture and environment, the SMO component 402 can be associated with (e.g., communicatively connected to) the RIC 404 and/or the RAN 406 (and/or one or more other RANs) via an interface(s) (e.g., an O1 interface, an A1 interface, or another interface), to facilitate communication of information between the SMO component 402 and the RIC 404 and/or the RAN 406 (and/or one or more other RANs), and the RIC 404 can be associated with the RAN 406 (and/or one or more other RANs) via an interface(s) (e.g., an E2 interface or another interface), to facilitate communication of information between the RIC 404 and the RAN 406 (and/or one or more other RANs).

The SMO component 402 can act and operate as a management and orchestration layer that can control configuration and automation aspects of the RIC 404 and RAN elements of the RAN(s) 406. The SMO component 402 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 404 can operate to control (e.g., manage) and enhance (e.g., improve or optimize) RAN functions and services of the RAN(s) 406. At least some of the various network functions and components of the RIC 404 can operate in real time or near real time, and some network functions and components of the RIC 404 may operate in non-real time.

In accordance with various embodiments, the system 400 can comprise a processor component 448 that can be associated with (e.g., communicatively connected to) and can work in conjunction with other components of the system 400, including the SMO component 402, the RIC 404, the RAN 406, the transparent layer 436, the accelerator function manager component 438, a data store 450, and/or other components of the system 400, to facilitate performing the various functions and operations of the system 400. The processor component 448 can employ one or more processors (e.g., one or more CPUs), accelerators, GPUs, ASICs, microprocessors, controllers, microcontrollers, or other processors) that can process information relating to data, files, services, applications, RANs, cells, communication network, core network, devices, users, data traffic, communication sessions (e.g., PDU or other communication sessions), condition or measurement reports, accelerator functions, the transparent layer, rules, L2 layer, L1 layers, vendor information, AI/ML-based models, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined accelerator function management criteria, algorithms (e.g., enhanced accelerator function management algorithms, AI algorithms, hash algorithms, data compression algorithms, data decompression algorithms, and/or other algorithm), interfaces, protocols, tools, and/or other information, to facilitate operation of the system 400, and control data flow between the system 400 and/or other components (e.g., network equipment, components, or functions, the communication network 102, the core network 104, another base station, a device (e.g., 110 or 112), a node, an application, a service, a user, or other entity) associated with the system 400.

The data store 450 can store data structures (e.g., user data, metadata), code structure(s) (e.g., modules, objects, hashes, classes, procedures) or instructions, information relating to data, files, services, applications, RANs, cells, communication network, core network, devices, users, data traffic, communication sessions (e.g., PDU or other communication sessions), condition or measurement reports, accelerator functions, the transparent layer, rules, L2 layer, L1 layers, vendor information, AI/ML-based models, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined accelerator function management criteria, algorithms (e.g., enhanced accelerator function management algorithms, AI algorithms, hash algorithms, data compression algorithms, data decompression algorithms, and/or other algorithm), interfaces, protocols, tools, and/or other information, to facilitate controlling or performing operations associated with the system 400. The data store 450 can comprise volatile and/or non-volatile memory, such as described herein. In an aspect, the processor component 448 can be functionally coupled (e.g., through a memory bus) to the data store 450 in order to store and retrieve information desired to operate and/or confer functionality, at least in part, to the SMO component 402, the RIC 404, the RAN 406, the transparent layer 436, the accelerator function manager component 438, the processor component 448, the data store 450, and/or other component of the system 400, and/or substantially any other operational aspects of system 400.

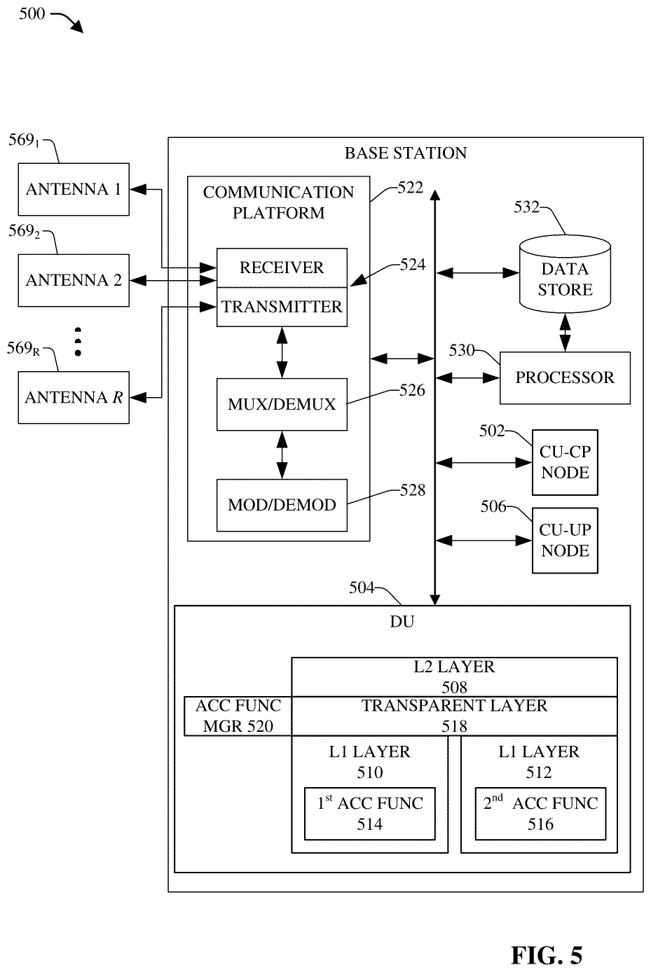

Turning to FIG. 5, FIG. 5 depicts a diagram of a non-limiting example base station 500 that can desirably facilitate (e.g., enable) connections (e.g., wireless connections) and communication of information associated with devices, in accordance with various aspects and embodiments of the disclosed subject matter. In some embodiments, the base station 500 can be a 5G or other NR base station (e.g., gNB or other NR-type or xG base station, wherein x can be a number greater than 5). In other embodiments, the base station 500 can be a 4G or LTE base station, can be a base station that can comprise 5G/NR functionality and 4G/LTE functionality, or can be some other type of base station (e.g., other type of access point).

With regard to a 5G or other NR base station, the base station 500 can comprise a CU-CP node 502 (e.g., a gNB or other NR-NB CU-CP node), one or more DUs (e.g., a gNB or other NR-NB DUs), including DU 504, a desired number of CU-UP nodes (e.g., a gNB or other NR-NB CU-UP nodes), including CU-UP node 506, and/or other network equipment. The CU-CP node 502 can be associated or interfaced with the DUs (e.g., DU 504) via an interface (e.g., F1-C interface) or connection. The CU-CP node 502 can be associated, or interfaced, with the CU-UP nodes (e.g., CU-UP node 506) via an interface (e.g., E1 interface) or connection. The one or more CU-UP nodes (e.g., CU-UP node 506) can be associated or interfaced with the one or more DUs (e.g., DU 504) via an interface (e.g., F1-U interface) or connection.

A DU (e.g., DU 504) can provide support for lower layers of a protocol stack. For instance, a DU (e.g., DU 504) can be a logical node that can host or handle baseband (e.g., PHY) and L2 (e.g., MAC and RLC layer) functionality associated with the base station 500. A CU-UP node (e.g., CU-UP node 506) can be a logical node that can host or handle data traffic between the core network 104 (e.g., 5G or other NR or xG core network) and the DU(s) (e.g., DU 504) to which the particular CU-UP is connected. The CU-CP node 502 can be a logical node that can host or handle L3 (e.g., RRC and PDCP layer) control plane functionality associated with the base station 500. In some embodiments, a device(s) (e.g., device(s) 110 and/or 112) can be connected to the base station 500, via the DU 504, wherein the CU-UP node 506 and the DU 504 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 500.

In certain embodiments, the DU 504 can comprise an L2 layer 508 and L1 layers 510 and 512. In some embodiments, the L1 layer 510 can comprise or be associated with the first accelerator function 514 (e.g., look-aside accelerator function), and the L1 layer 512 can comprise or be associated with the second accelerator function 516 (e.g., inline accelerator function), such as described herein. In certain embodiments, the DU 504 also can comprise or be associated with the transparent layer 518 and the accelerator function manager component 520 that part of or can be associated with the DU 504 and/or other components of the base station 500. The transparent layer 518 and the accelerator function manager component 520 can comprise various respective components and functions, and can perform various respective operations, such as described herein. In some embodiments, the accelerator function manager component 520 can desirably manage access and utilization of the respective accelerator functions (e.g., 514, 516) associated with the respective L1 layers (e.g., 510, 512) by the L2 layer 508 (e.g., a single L2 layer or single instance of L2 layer), via the transparent layer 518, in accordance with the defined accelerator function management criteria, such as described herein.

The base station 500 can receive and transmit signal(s) from and to wireless devices like access points (e.g., base stations, femtocells, picocells, or other type of access point), access terminals (e.g., UEs), wireless ports and routers, and the like, through a set of antennas 5691-569R. In an aspect, the antennas 5691-569R can be a part of a communication platform 522, which comprises electronic components and associated circuitry that can provide for processing and manipulation of received signal(s) and signal(s) to be transmitted. In an aspect, the communication platform 522 can include a receiver/transmitter 524 that can convert signal from analog to digital upon reception, and from digital to analog upon transmission. In addition, receiver/transmitter 524 can divide a single data stream into multiple, parallel data streams, or perform the reciprocal operation. In accordance with various embodiments, the communication platform 522 can be, can comprise, or can be associated with an RU (e.g., a gNB or other NR-NB RU node).

In an aspect, coupled to receiver/transmitter 524 can be a multiplexer/demultiplexer (mux/demux) 526 that can facilitate manipulation of signal in time and frequency space. The mux/demux 526 can multiplex information (e.g., data/traffic and control/signaling) according to various multiplexing schemes, such as, for example, time division multiplexing (TDM), frequency division multiplexing (FDM), orthogonal frequency division multiplexing (OFDM), code division multiplexing (CDM), space division multiplexing (SDM), or other multiplexing scheme. In addition, mux/demux component 526 can scramble and spread information (e.g., codes) according to substantially any code known in the art, e.g., Hadamard-Walsh codes, Baker codes, Kasami codes, polyphase codes, and so on. A modulator/demodulator (mod/demod) 528 also can be part of the communication platform 522, and can modulate information according to multiple modulation techniques, such as frequency modulation, amplitude modulation (e.g., M-ary quadrature amplitude modulation (QAM), with M a positive integer), phase-shift keying (PSK), and the like.

The base station 500 also can comprise a processor(s) 530 that can be configured to confer and/or facilitate providing functionality, at least partially, to substantially any electronic component in or associated with the base station 500. For instance, the processor(s) 530 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 500 can include a data store 532 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices; information relating to data, files, services, applications, RANs, cells, communication network, core network, devices, users, data traffic, communication sessions (e.g., PDU or other communication sessions), condition or measurement reports, accelerator functions, the transparent layer, rules, L2 layer, L1 layers, vendor information, AI/ML-based models, AI-related data, training data, feedback information, predictions, inferences, threshold (e.g., maximum, minimum, or other threshold) values, weight values, data processing operations, messages, notifications, alarms, alerts, preferences, hash values, metadata, parameters, hyperparameters, traffic flows, tables, mappings, policies, the defined accelerator function management criteria, algorithms (e.g., enhanced accelerator function management algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 530 can employ one or more processors (e.g., one or more CPUs, accelerators, GPUs, ASICs, or other processors), microprocessors, or controllers) that can process information, and can be coupled to the data store 532 in order to store and retrieve at least some of the information (e.g., information, such as algorithms, relating to multiplexing/demultiplexing or modulation/demodulation; information relating to radio link levels; information relating to data, files, services, applications, RANs, cells, communication network, core network, devices, users, data traffic, communication sessions (e.g., PDU or other communication sessions), condition or measurement reports, accelerator functions, the transparent layer, rules, L2 layer, L1 layers, vendor information, AI/ML-based models, AI-related data, training data, feedback information, predictions, inferences, threshold (e.g., maximum, minimum, or other threshold) values, weight values, data processing operations, messages, notifications, alarms, alerts, preferences, hash values, metadata, parameters, hyperparameters, traffic flows, tables, mappings, policies, the defined accelerator function management criteria, algorithms, interfaces, protocols, tools, and/or other information) desired to operate and/or confer functionality to the communication platform 522 and/or other operational components of the base station 500. The data store 532 can comprise volatile memory and/or nonvolatile memory, such as described herein.

With further regard to the data stores and memory disclosed herein, the data store (e.g., 450 or 532) or memory can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects is intended to comprise, without being limited to, these and other suitable types of memory.

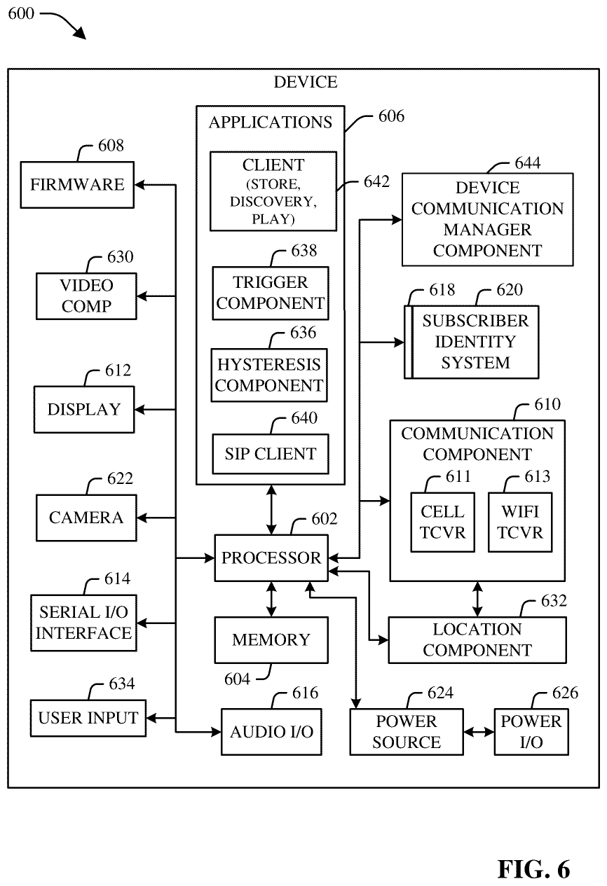

Referring to FIG. 6, FIG. 6 illustrates a diagram of a non-limiting example device 600 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 600 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 600, can typically include a variety of machine-readable media. Machine-readable media can be any available media that can be accessed by the computer and include both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 600 can include a processor(s) 602 for controlling and processing all onboard operations and functions. The processor(s) 602 can comprise one or more processors (e.g., one or more CPUs, accelerators, GPUs, ASICs, or other processors), microprocessors, or controllers) that can process information associated with the device 600. A memory 604 can interface to the processor(s) 602 for storage of data and one or more applications 606 (e.g., a video player software, user feedback component software, or other application). Other applications can include voice recognition of predetermined voice commands that facilitate initiation of the user feedback signals. Still other applications can comprise an AI application. The applications 606 can be stored in the memory 604 and/or in a firmware 608, and executed by the processor(s) 602 from either or both the memory 604 or/and the firmware 608. The firmware 608 can also store startup code for execution in initializing the device 600. A communication component 610 interfaces to the processor(s) 602 to facilitate wired/wireless communication with external systems, e.g., cellular networks, VoIP networks, and so on. Here, the communication component 610 can also include a suitable cellular transceiver 611 (e.g., a global system for mobile communication (GSM), orthogonal frequency division multiple access (OFDMA), 4G, LTE, 5G, other NR, or other type of transceiver) and/or an unlicensed transceiver 613 (e.g., Wi-Fi, WiMax) for corresponding signal communications. The device 600 can be a device such as a cellular telephone, a PDA with mobile communications capabilities, and messaging-centric devices. The communication component 610 also facilitates communications reception from terrestrial radio networks (e.g., broadcast), digital satellite radio networks, and Internet-based radio services networks.

The device 600 includes a display 612 for displaying text, images, video, telephony functions (e.g., a Caller ID function), setup functions, and for user input. For example, the display 612 can also be referred to as a “screen” that can accommodate the presentation of multimedia content (e.g., music metadata, messages, wallpaper, graphics, etc.). The display 612 can also display videos and can facilitate the generation, editing and sharing of video quotes. A serial I/O interface 614 is provided in communication with the processor(s) 602 to facilitate wired and/or wireless serial communications (e.g., USB, and/or IEEE 1394) through a hardwire connection, and other serial input devices (e.g., a keyboard, keypad, and mouse). This supports updating and troubleshooting the device 600, for example. Audio capabilities are provided with an audio I/O component 616, which can include a speaker for the output of audio signals related to, for example, indication that the user pressed the proper key or key combination to initiate the user feedback signal. The audio I/O component 616 also facilitates the input of audio signals through a microphone to record data and/or telephony voice data, and for inputting voice signals for telephone conversations.

The device 600 can include a slot interface 618 for accommodating a SIC (Subscriber Identity Component) in the form factor of a card Subscriber Identity Module (SIM) or universal SIM 620, and interfacing the SIM card 620 with the processor(s) 602. However, it is to be appreciated that the SIM card 620 can be manufactured into the device 600, and updated by downloading data and software.

The device 600 can process IP data traffic through the communication component 610 to accommodate IP traffic from an IP network such as, for example, the Internet, a corporate intranet, a home network, a person area network, etc., through an ISP or broadband cable provider. Thus, VOIP traffic can be utilized by the device 600 and IP-based multimedia content can be received in either an encoded or a decoded format.

A video processing component 622 (e.g., a camera) can be provided for decoding encoded multimedia content. The video processing component 622 can aid in facilitating the generation, editing, and sharing of video quotes. The device 600 also includes a power source 624 in the form of batteries and/or an AC power subsystem, which power source 624 can interface to an external power system or charging equipment (not shown) by a power I/O component 626.

The device 600 can also include a video component 630 for processing video content received and, for recording and transmitting video content. For example, the video component 630 can facilitate the generation, editing and sharing of video quotes. A location tracking component 632 facilitates geographically locating the device 600. As described hereinabove, this can occur when the user initiates the feedback signal automatically or manually. A user input component 634 facilitates the user initiating the quality feedback signal. The user input component 634 can also facilitate the generation, editing and sharing of video quotes. The user input component 634 can include such conventional input device technologies such as a keypad, keyboard, mouse, stylus pen, and/or touch screen, for example.

Referring again to the applications 606, a hysteresis component 636 facilitates the analysis and processing of hysteresis data, which is utilized to determine when to associate with the access point. A software trigger component 638 can be provided that facilitates triggering of the hysteresis component 636 when the Wi-Fi transceiver 613 detects the beacon of the access point. A SIP client 640 enables the device 600 to support SIP protocols and register the subscriber with the SIP registrar server. The applications 606 can also include a client 642 that provides at least the capability of discovery, play and storage of multimedia content, for example, music.

The device 600, as indicated above related to the communication component 610, includes an indoor network radio transceiver 613 (e.g., Wi-Fi transceiver). This function supports the indoor radio link, such as IEEE 802.11, for the dual-mode GSM device (e.g., device 600). The device 600 can accommodate at least satellite radio services through a device (e.g., handset device) that can combine wireless voice and digital radio chipsets into a single device (e.g., single handheld device).

It is to be appreciated and understood that one or more components (e.g., the devices, configuration manager component, base station, core network, or other component) of the systems (e.g., system 100, system 400, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

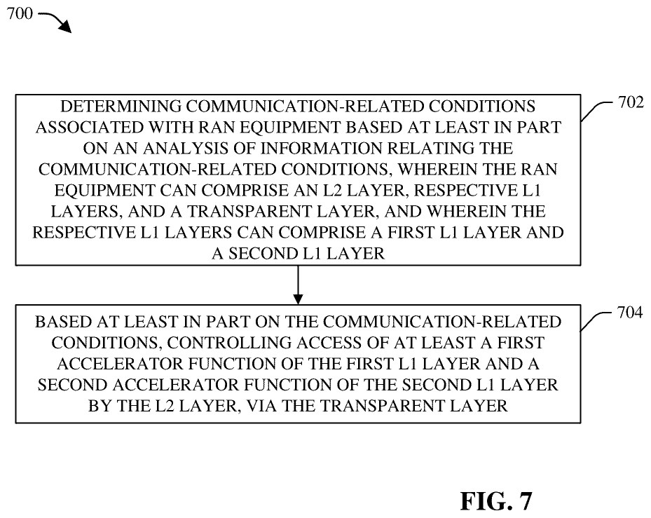

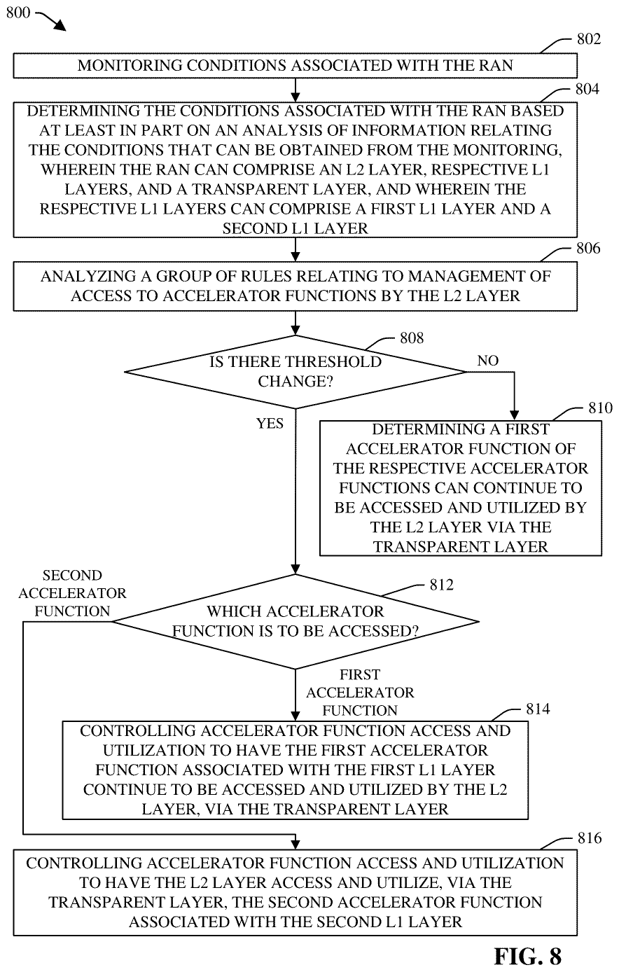

In view of the example systems and/or devices described herein, example methods that can be implemented in accordance with the disclosed subject matter can be further appreciated with reference to flowcharts in FIGS. 7-8. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that can desirably (e.g., automatically, dynamically, suitably, reliably, efficiently, enhancedly, and/or optimally) manage access (e.g., concurrent access) and utilization of respective accelerator functions of respective L1 layers by an L2 layer, via a transparent layer, of a RAN, in accordance with various aspects and embodiments of the disclosed subject matter. The method 700 can be employed by, for example, a system comprising the RAN, which can comprise the transparent layer, the accelerator function manager component, the processor component, the data store, and/or other components.

At 702, communication-related conditions associated with RAN equipment can be determined based at least in part on an analysis of information relating the communication-related conditions, wherein the RAN equipment can comprise an L2 layer, respective L1 layers, and a transparent layer, and wherein the respective L1 layers can comprise a first L1 layer and a second L1 layer. In some embodiments, the transparent layer can be associated with (e.g., logically or physically situated between and communicatively connected or interfaced to) the L2 layer (e.g., the single L2 layer) and the respective L1 layers, wherein the transparent layer can comprise or be associated with the accelerator function manager component. In certain embodiments, the accelerator function manager component (or another component of the system) can determine the communication-related conditions associated with the RAN equipment of the RAN based at least in part on the results of the analysis of the information relating the communication-related conditions.

At 704, based at least in part on the communication-related conditions, access of at least a first accelerator function of the first L1 layer and a second accelerator function of the second L1 layer by the L2 layer, via the transparent layer, can be controlled (e.g., utilizing a transparent layer function of the accelerator function manager component). For instance, based at least in part on the communication-related conditions, the accelerator function manager component (e.g., utilizing the transparent layer function) can control (e.g., manage) access and utilization (e.g., individual or concurrent access and utilization), by the L2 layer (e.g., L2 MAC layer) via the transparent layer, of at least the first accelerator function (e.g., the look-aside or other accelerator function) of or associated with the first L1 layer and a second accelerator function (e.g., the inline or other accelerator function) of or associated with the second L1 layer, such as described herein.

FIG. 8 depicts a flow chart of another example method 800 that can desirably (e.g., automatically, dynamically, suitably, reliably, efficiently, enhancedly, and/or optimally) manage access (e.g., concurrent access) and utilization of respective accelerator functions of respective L1 layers by an L2 layer, via a transparent layer, of a RAN, in accordance with various aspects and embodiments of the disclosed subject matter. The method 800 can be employed by, for example, a system comprising the RAN, which can comprise the transparent layer, the accelerator function manager component, the processor component, the data store, and/or other components.

At 802, conditions associated with the RAN can be monitored. In some embodiments, the accelerator function manager component (or another component of or associated with the RAN) can monitor the conditions (e.g., communication-related conditions or other conditions) associated with the RAN (e.g., RU, DU, CU, and/or cells of the RAN, and/or devices associated with the RAN).

At 804, the conditions associated with the RAN can be determined based at least in part on an analysis of information relating the conditions that can be obtained from the monitoring, wherein the RAN can comprise an L2 layer, respective L1 layers, and a transparent layer, and wherein the respective L1 layers can comprise a first L1 layer and a second L1 layer. In some embodiments, the transparent layer can be associated with (e.g., logically or physically situated between and communicatively connected or interfaced to) the L2 layer (e.g., the single L2 MAC layer) and the respective L1 layers, wherein the transparent layer can comprise or be associated with the accelerator function manager component. In certain embodiments, the accelerator function manager component (or another component of the system) can determine the communication-related conditions associated with the RAN of the RAN based at least in part on the results of the analysis of the information relating the communication-related conditions.

At 806, a group of rules relating to management of access to accelerator functions by the L2 layer can be analyzed. For instance, the accelerator function manager component can monitor and analyze the group of rules to facilitate determining whether there has been a change (e.g., a threshold change) in the group of rules. The accelerator function manager component also can analyze the group of rules, in connection with the analysis of the information relating the conditions, to facilitate determining whether there has be a change (e.g., a threshold change) in the conditions associated with the RAN.

At 808, a determination can be made regarding whether there is a threshold amount of change in the conditions or a threshold change in the group of rules, based at least in part on the results of analyzing the conditions associated with the RAN and the group of rules. In some embodiments, the accelerator function manager component can determine whether there is the threshold amount of change in the conditions or the threshold change in the group of rules, based at least in part on the results of analyzing the conditions associated with the RAN and the group of rules, such as described herein.

If it is determined that there is not the threshold amount of change in the conditions or the threshold change in the group of rules, at 810, a determination can be made that a first accelerator function of the respective accelerator functions can continue to be accessed and utilized by the L2 layer via the transparent layer. For instance, if, based at least in part on the results of analyzing the conditions associated with the RAN and the group of rules, the accelerator function manager component determines that there is not the threshold amount of change in the conditions or the threshold change in the group of rules, the accelerator function manager component can determine that the first (e.g., current) accelerator function of the respective accelerator functions (e.g., the look-aside accelerator function, the inline accelerator function, or other accelerator function) can continue to be accessed and utilized by the L2 layer via the transparent layer. In some embodiments, the first accelerator function can be associated with the first L1 layer, which can be associated with a cell of the RAN.

Referring again to reference numeral 808, if, instead, at 808, it is determined that there is the threshold amount of change in the conditions or the threshold change in the group of rules, at 812, a determination can be made regarding which of the respective accelerator functions is to be accessed and utilized by the L2 layer, via the transparent layer, based at least in part on the conditions associated with the RAN and the group of rules (e.g., the group of rules or updated group of rules, if updated). In some embodiments, if it is determined that there is the threshold amount of change in the conditions or the threshold change in the group of rules, the accelerator function manager component can determine which of the respective accelerator functions is to be accessed and utilized by the L2 layer, via the transparent layer, based at least in part on the conditions associated with the RAN, the group of rules, and/or the respective accelerator functions (e.g., the characteristics or conditions of or associated with the respective accelerator functions).

If, based at least in part on the conditions associated with the RAN, the group of rules, and/or the respective accelerator functions, it is determined that the first accelerator function of the respective accelerator functions is to continue to be accessed and utilized by the L2 layer, via the transparent layer, at 814, accelerator function access and utilization can be controlled to have the first accelerator function associated with the first L1 layer continue to be accessed and utilized by the L2 layer, via the transparent layer. If, instead, based at least in part on the conditions associated with the RAN, the group of rules, and/or the respective accelerator functions, it is determined that the L2 layer is to access and utilize, via the transparent layer, a second accelerator function of the respective accelerator functions, at 816, accelerator function access and utilization can be controlled to have the L2 layer access and utilize, via the transparent layer, the second accelerator function associated with the second L1 layer. In certain embodiments, if, based at least in part on the conditions associated with the RAN, the group of rules, and/or the respective accelerator functions, the accelerator function manager component determines that the first accelerator function is to continue to be accessed and utilized by the L2 layer, via the transparent layer (e.g., even though it is determined that there is the threshold amount of change in the conditions or the threshold change in the group of rules), the accelerator function manager component can determine that the first accelerator function can continue to be accessed and utilized by the L2 layer, via the transparent layer, and can control accelerator function access and utilization to have the first accelerator function continue to be accessed and utilized by the L2 layer, via the transparent layer. In some embodiments, if, instead, based at least in part on the conditions associated with the RAN, the group of rules, and/or the respective accelerator functions, the accelerator function manager component determines that the L2 layer, via the transparent layer, is to change from accessing and utilizing the first accelerator function to accessing and utilizing the second accelerator function, the accelerator function manager component can control accelerator function access and utilization to have the L2 layer, via the transparent layer, access and utilize the second accelerator function associated with the second L1 layer.

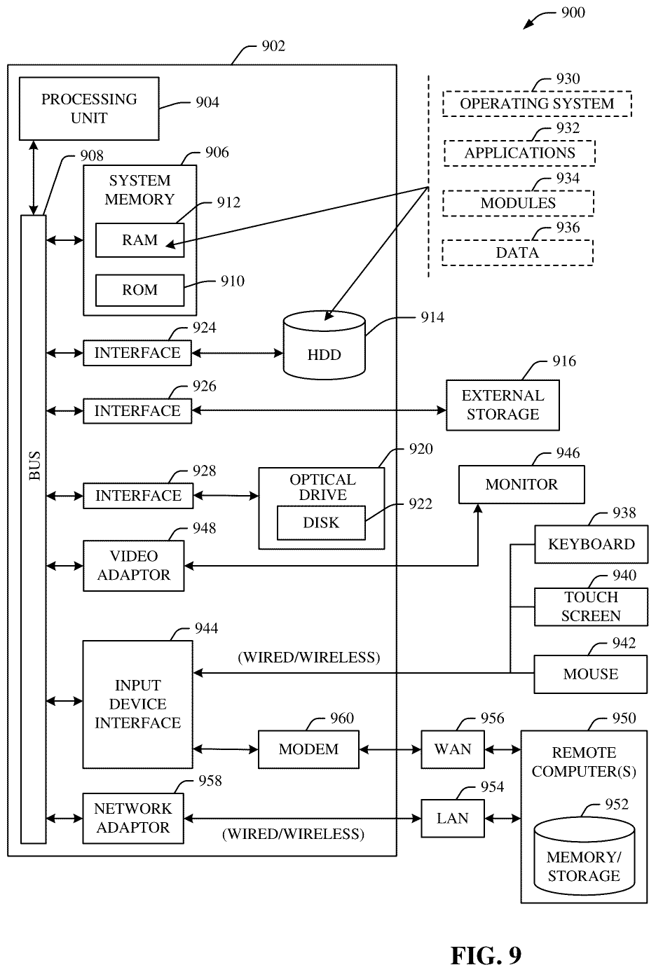

In order to provide additional context for various embodiments described herein, FIG. 9 and the following discussion are intended to provide a brief, general description of a suitable computing environment 900 in which the various embodiments of the embodiments described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 also can be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956, e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, DU, L1 layer, L2 layer, transparent layer, accelerator function manager component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
determining, by a system comprising at least one processor, communication-related conditions associated with radio access network equipment based on an analysis of information relating to the communication-related conditions, wherein the radio access network equipment comprises a layer two layer, respective layer one layers, and a transparent layer, and wherein the respective layer one layers comprise a first layer one layer and a second layer one layer; and
based on the communication-related conditions, controlling, utilizing a transparent layer function of the system, access of at least a first accelerator function of the first layer one layer and a second accelerator function of the second layer one layer by the layer two layer via the transparent layer.

2. The method of claim 1, wherein the transparent layer and the transparent layer function enable the layer two layer to concurrently access the first accelerator function of the first layer one layer and the second accelerator function of the second layer one layer via the transparent layer.

3. The method of claim 1, wherein the first accelerator function is a look-aside accelerator function, and wherein the second accelerator function is an inline accelerator function.

4. The method of claim 1, wherein the controlling comprises: based on the communication-related conditions and a group of rules relating to management of access to accelerator functions by the layer two layer, controlling, utilizing the transparent layer function, access of at least the first accelerator function of the first layer one layer and the second accelerator function of the second layer one layer by the layer two layer via the transparent layer.

5. The method of claim 4, wherein the group of rules indicates respective first communication-related conditions under which the first accelerator function is to be accessed and utilized by the layer two layer via the transparent layer, and respective second communication-related conditions under which the second accelerator function is to be accessed and utilized by the layer two layer via the transparent layer.

6. The method of claim 4, further comprising:
based on the analysis of the information relating to the communication-related conditions, determining, utilizing the transparent layer function, whether a threshold amount of change in at least one of the communication-related conditions has occurred; and
in response to determining that the threshold amount of change in at least one of the communication-related conditions has occurred, determining, utilizing the transparent layer function, whether to change from the layer two layer accessing and utilizing one of the first accelerator function or the second accelerator function to the layer two layer accessing and utilizing another one of the first accelerator function or the second accelerator function, based on the communication-related conditions and the group of rules.

7. The method of claim 4, further comprising:
based on the communication-related conditions, determining, utilizing the transparent layer function, a first amount of energy and a first quality of service associated with utilization of the first accelerator function;
based on the communication-related conditions, determining, utilizing the transparent layer function, a second amount of energy and a second quality of service associated with utilization of the second accelerator function, wherein the first amount of energy is less than the second amount of energy; and
one of:
based on the group of rules, determining, utilizing the transparent layer function, that the first accelerator function is to be utilized by the layer two layer via the transparent layer based on determining that the first amount of energy is less than the second amount of energy and based on determining that the first quality of service satisfies a defined threshold quality of service; or
based on the group of rules, determining, utilizing the transparent layer function, that the second accelerator function is to be utilized by the layer two layer via the transparent layer based on determining that the first quality of service does not satisfy the defined threshold quality of service, even though the first amount of energy is determined to be less than the second amount of energy.

8. The method of claim 4, further comprising:
based on the communication-related conditions and the group of rules, determining, utilizing the transparent layer function, that the layer two layer is to access, via the transparent layer, the first accelerator function of the first layer one layer associated with a first cell of the radio access network equipment; and
based on the communication-related conditions and the group of rules, determining, utilizing the transparent layer function, that the layer two layer is to access, via the transparent layer, the second accelerator function of the second layer one layer associated with a second cell of the radio access network equipment, wherein the layer two layer concurrently accesses, via the transparent layer, the first accelerator function and the second accelerator function.

9. The method of claim 8, wherein the first accelerator function is one of a look-aside accelerator function and an inline accelerator function, and the second accelerator function is another one of the look-aside accelerator function and the inline accelerator function, and wherein one of:
the first cell is one of a frequency-division-duplexing cell or a time-division-duplexing cell, and the second cell is another one of the frequency-division-duplexing cell or the time-division-duplexing cell;
the first cell is one of a sub-3 gigahertz cell or a sub-6 gigahertz cell, and the second cell is another one of the sub-3 gigahertz cell or the sub-6 gigahertz cell; or
the first cell is one of the sub-3 gigahertz cell or the millimeter wave cell, and the second cell is another one of the sub-3 gigahertz cell or the millimeter wave cell.

10. The method of claim 1, further comprising:
determining, by the system, a first latency associated with the first accelerator function and the transport layer based on a first accelerator function latency and a first transport layer latency relating to the first accelerator function;
determining, by the system, a second latency associated with the second accelerator function and the transport layer based on a second accelerator function latency and a second transport layer latency relating to the second accelerator function; and
compensating, by the system, for the first latency or the second latency in connection with uplink data communications or downlink data communications associated with the radio access network equipment.

11. The method of claim 1, wherein the communication-related conditions relate to at least one of a duplex type utilized for data communication, a carrier band, a carrier bandwidth, an active spectrum, a numerology, a time to interval, respective perceived quality of service values of the respective layer one layers, a mapping of respective accelerator functions to respective time periods, an event, a hardware fault, a software fault, a maintenance activity, or an upgrade activity associated the radio access network equipment, and wherein the respective accelerator functions comprise at least the first accelerator function and the second accelerator function.

12. A system, comprising:
at least one memory that stores computer executable components; and
at least one processor that executes computer executable components stored in the at least one memory, wherein the computer executable components comprise:
a condition evaluator that determines conditions associated with radio access network equipment based on an evaluation of condition data relating to the conditions, wherein the radio access network equipment comprises a layer two layer, respective layer one layers, and a transparent layer, and wherein the respective layer one layers comprise a first layer one layer and a second layer one layer; and
an accelerator function manager of the transparent layer that, based on the conditions, manages access, by the layer two layer via the transparent layer, of at least a first accelerator function of the first layer one layer and a second accelerator function of the second layer one layer.

13. The system of claim 12, wherein, based on the conditions and a group of rules relating to management of access to accelerator functions, the accelerator function manager controls access, by the layer two layer via the transparent layer, of at least the first accelerator function of the first layer one layer and the second accelerator function of the second layer one layer, and wherein the transparent layer and the accelerator function manager enable the layer two layer to access and utilize, via the transparent layer, the first accelerator function of the first layer one layer and the second accelerator function of the second layer one layer in parallel.

14. The system of claim 13, wherein the group of rules indicates respective first conditions under which the first accelerator function is to be accessed and utilized by the layer two layer via the transparent layer, and respective second conditions under which the second accelerator function is to be accessed and utilized by the layer two layer via the transparent layer.

15. The system of claim 13, wherein, based on the evaluation of the condition data relating to the conditions, the accelerator function manager determines whether a threshold amount of change in at least one of the conditions has occurred, wherein, in response to determining that the threshold amount of change in at least one of the conditions has occurred, the accelerator function manager determines whether to change from one of the first accelerator function or the second accelerator function to another one of the first accelerator function or the second accelerator function, based on the conditions and the group of rules, wherein the first accelerator function is a look-aside accelerator function, and wherein the second accelerator function is an inline accelerator function.

16. The system of claim 12, wherein the transparent layer is transparent or agnostic with respect to the respective layer one layers, and transparent or agnostic with respect to the layer two layer.

17. The system of claim 12, wherein the radio access network equipment is part of a disaggregated radio access network, wherein the disaggregated radio access network comprises a distributed unit located in a first location, a central unit located in the first location or a second location, and a radio unit located in the first location, the second location, or a third location, and wherein the accelerator function manager and the transparent layer are associated with the distributed unit.

18. The system of claim 12, wherein accelerator function manager or the transparent layer employs a central processing unit or a general purpose processor to facilitate performance of accelerator function management functions of the accelerator function manager, and wherein the accelerator function management functions comprise management of access, by the layer two layer via the transparent layer, of at least the first accelerator function and the second accelerator function.

19. A non-transitory machine-readable medium, comprising executable instructions that, when executed by at least one processor, facilitate performance of operations, comprising:
evaluating conditions associated with a base station based on condition information relating the conditions, wherein the base station comprises a layer two layer, respective layer one layers, and a transparent layer, and wherein the respective layer one layers comprise a first layer one layer and a second layer one layer; and
based on the evaluation of the conditions, controlling access of at least a first accelerator function of the first layer one layer and a second accelerator function of the second layer one layer by the layer two layer via the transparent layer.

20. The non-transitory machine-readable medium of claim 19, wherein the controlling comprises:
based on the evaluating of the conditions and a group of rules relating to management of access to accelerator functions:
determining whether a threshold amount of change in at least one of the conditions has occurred; and
based on a result of determining whether the threshold amount of change in at least one of the conditions has occurred, determining whether to change from the layer two layer accessing and utilizing one of the first accelerator function or the second accelerator function to the layer two layer accessing and utilizing another one of the first accelerator function or the second accelerator function,
wherein the first accelerator function is a look-aside accelerator function, and wherein the second accelerator function is an inline accelerator function.
